(19) United States
(12) Patent Application Publication
(10) Pub. No.: US 2011/0103260 A1
(43) Pub. Date: May 5, 2011

(54) BINDING CACHE CREATING METHOD, BINDING CACHE CREATING SYSTEM, HOME AGENT, AND MOBILE NODE

(75) Inventors: Mohana Dhamayanthi Jeyatharan, Singapore (SG); Keigo Aso, Kanagawa (JP); Chan Wah Ng, Singapore (SG); Chun Keong Benjamin Lim, Singapore (SG)

(73) Assignee: PANASONIC CORPORATION, Osaka (JP)

(21) Appl. No.: 12/997,951

(22) PCT Filed: Jun. 11, 2009
(86) PCT No.: PCT/JP2009/002637

§ 371 Date: Dec. 14, 2010

(30) Foreign Application Priority Data
Jun. 16, 2008 (JP) 2008-156487
Mar. 23, 2009 (JP) 2009-069493

(51) Int. Cl. H04L 12/46

(52) U.S. Cl. 370/254

(57) ABSTRACT

Disclosed is a technique to, when a mobile node including a plurality of interfaces roams in a home domain, reduce signaling to create a client-based binding cache in a home agent and manages the same. When a MN (10) refers to a home MIPv6 prefix (P1) via an interface (If1) to find attachment to a home MIPv6 domain, the MN (10) predicts a high probability that another WLAN interface (If2) of the MN (10) connects with the same home MIPv6 domain (100) and an LMA/HA (40) and transmits a CMIPv6 cache creation•maintenance/management request message (308) to the LMA/HA (40). Receiving the request message (308), the LMA/HA (40) creates a CMIPv6 cache relating to the PMIPv6 cache of the WLAN interface (If2) and maintains/manages the CMIPv6 cache without being refreshed by the MN (10).

### TECHNICAL FIELD

The present invention relates to a binding cache creating method and a binding cache creating system when a mobile node with a plurality of interfaces roams in a home domain.

The present invention further relates to a home agent and a mobile node in the binding cache creation system.

### BACKGROUND ART

Currently a lot of communication devices conduct communication using Internet Protocol version 6 (IPv6). In order to provide mobile devices with mobility support, the Internet Engineering Task Force (IETF) has developed Mobility Support in IPv6 (MIPv6) as described in the following Non-Patent Document 1. The mobility support in Non-Patent Document 1 is implemented by introducing an entity called a home agent into a home network of a mobile node (MN). The MN registers, with the HA, a care-of address (CoA) acquired at a foreign link using a message called a binding update (BU) message. The BU message allows the HA to create binding (position information) between a home address (HoA) as an address acquired from a home link and the CoA of the MN. The HA intercepts a message addressed to the HoA of the MN based on the binding, and encapsulates the message into a packet addressed to the CoA of the MN for transferring. Herein, this packet encapsulation is the processing to set a received packet at a payload of a new packet, which is known as packet tunneling.

One problem of MIPv6 is that a MN has to update a correspondent node (CN) and one or a plurality of HAs every time network attachment changes or when the lifetime of binding expires. This updating increases a load of signaling that the MN moving at a high speed sends to a wireless network. Further, handoff establishment conducted with a CN every time network attachment changes requires long time duration, because a Return Routability (RR) message and a BU message have to be transmitted/received every time network attachment change. Thus, jitter and a packet loss occur during a session related to a flow or a connection because handoff establishment requires a considerable time. Such jitter is not favorable for real time applications such as Voice over IP (VoIP), multimedia and video streaming. The packet loss is not favorable for a flow to transmit information on important text and data. Further, when a Transmission Control Protocol (TCP) is used to transfer important data for an application, the packet loss reduces throughput of the TCP.

Directing attention to problems of MIPv6, the focus is currently shifted to a network-based local mobility-management (NetLMM) protocol. The NetLMM working group of the IETF is working on this protocol. The network-based local mobility-management refers to management of the mobility of a MN located in a geographically local network segment by a network entity rather than by the MN itself.

To achieve an object of a network-based local mobility-management that is transparent to a MN, the MN is required to refer to the same prefix at any place in a local domain. This prefix has to be acquired from a router located at an upper layer of a routing hierarchy. Such a router preferably is located at a default routing path for every MN in the local domain so that advantages of the local mobility-management can be obtained. This router has to keep reachability information that is a route of the above prefix, i.e., routing information (prefix-based route). As a result, this prefix-based route has to be created by a network entity.

A special network-based local mobility-management protocol examined by the NetLMM working group is Proxy Mobile Internet Protocol version 6 (PMIPv6) disclosed in the following Non-Patent Document 2. The protocol of PMIPv6 is mainly designed to provide a normal IPv6 host without Client Mobile IPv6 (CMIPv6) stack with a mobility management service at a local part of a network. However, PMIPv6 is effective also for a node with CMIPv6 stack. This is because, when a MN with CMIPv6 stack is located in a foreign PMIPv6 domain and refers to the same prefix (a foreign PMIPv6 local prefix that is routed in a foreign local mobility anchor (LMA)/HA) via a certain interface in the local domain, there is no need for the MN to execute any global registration. Further, although the above MN with CMIPv6 stack changes its geographical position when roaming into the home domain, there is no need to participate in position registration while continuously referring to its own home network prefix.

The following outlines PMIPv6 disclosed in Non-Patent Document 2. When a certain MN is attached to a certain PMIPv6, the MN provides its own network access identifier (NAI) during association with a mobile access gateway (MAG). The MAG is a router to which the MN is directly attached, and is a router (proxy node) with which the MN executes local registration as the proxy of the MN with respect to a local mobility anchor (LMA) under the control thereof. The NAI is transferred to an AAA (Authentication, Authorization and Accounting) server for the purpose of attachment authentication. When the AAA server authorizes the network attachment of the MN, the AAA server returns a response to notify the MAG of success in attachment authentication. With the above response, the AAA server further provides some MN profiles such as a LMA address, an address configuration mode that MN has to be provided with during roaming in the local domain and special policy.

Acquiring the above MN parameters, the MAG transmits a proxy BU (PBU) message to the LMA. The MAG acquires a prefix relating to an interface to which the MN is attached from a proxy binding acknowledgement (PBA) message as a reply of the PBU message, and thereafter emulates the home link and the local home link. As stated above, the PBU message executed by the MAG, i.e., local registration is the same as a BU message in MIPv6 only except for a flag indicating that this message is a PBU message. The execution of the PBU message causes the reachability state of the MN to be created at the LMA. Basically, the LMA has the reachability state for the MN prefix acquired in the PMIPv6 domain, and an address reachable to this MN prefix is the address of the MAG.

The MN configures an address using the prefix received in the PMIPv6 domain with a stateful or a stateless address configuration mode. Since each MN acquires a unique prefix, a prefix-based cache in the LMA adequately reaches the MN. Each data packet reaching the LMA is tunneled to a MAG connected to the MN, and each data packet reaching from the MN to the MAG is tunneled to the LMA. A neighbor cache table of the MAG binds the PMIPv6 local address of the MN with a link layer address used to transmit a packet to the MN.

The following describes multihoming in a broad sense in the case where a MN includes a plurality of communication interfaces and each interface belongs to a different access technique, or in the case where a MN includes one interface that can process a plurality of different prefixes so that a plurality of different addresses can be configured for the same interface. The PMIPv6 protocol disclosed in Non-Patent Document 2 is designed with capability of supporting a MN including a plurality of interfaces so that all of the interfaces attach simultaneously. Basically, one unique prefix is assigned to each interface, and the PMIPv6 protocol guarantees each interface referring to the same prefix during roaming in the PMIPv6 domain. Thus, for the MN with a plurality of interfaces, a plurality of PMIPv6 bindings is maintained at the LMA, and bindings are maintained as individual mobility sessions each identified by a unique prefix.

The following Non-Patent Document 4 describes how a MN equipped with a MIPv6 function provides a multihoming support function in a HA when the MN roams in a foreign domain. The multihoming support function in Non-Patent Document 4 is a mechanism enabling a packet to reach via respective care-of addresses (CoA) relating to one or more interfaces of the MN so that advantages of the multihoming can be obtained. When the MN roams in a foreign domain, the HA as a geographical anchor point for MN home prefix has to keep binding information for MN CoA for the purpose of multihoming support. This binding information includes mapping of the home address (HoA) and individual CoAs relating to one or more interfaces of the MN. In order to maintain a plurality of bindings individually and at the same time, Non-Patent Document 4 describes using a binding identifier (BID). This BID uniquely identifies each interface, i.e., the CoA of each interface. The BID is created by the roaming MN and is transferred at the time of binding registration. The HA can use the BID to maintain registration allowing a packet addressed to one HoA to reach the individual CoAs.

The 3GPP (Third Generation Partnership Project) is working on a global and heterogeneous networks-coupled configuration including various types of wireless access' networks such as a wireless local area network (WLAN), a cellular network, the third generation (3G) cellular network or the 3.9 generation or the fourth generation, and a wireless wide area network (WAN) of a WiMAX format. The global and heterogeneous networks-coupled configuration is effective to implement seamless mobility and support different types of application services such as real time video, VoIP (Voice over IP), information and important data to be a high quality of service. The following Non-Patent Document 3 discloses that PMIPv6 will be adopted as a local mobility management (LMM) protocol in a 3GPP local domain. The 3GPP local domain may be configured with a 3G cellular network, a Trusted or Untrusted WLAN access network and a WiMAX access network. Further, a MN with a plurality of different types of interfaces may have to roam in a 3GPP local domain, and be attached simultaneously via various types of interfaces to implement multihoming. As other conventional techniques, the following Non-Patent Documents 5, 6 and 7 and Patent Documents 1 to 10 are disclosed.

### PRIOR ART DOCUMENT

### Patent Document

Patent Document 1: Aghvami, A. H., et. al., “Method of discovering multi-mode mobile terminals”, US Patent No. US20060166699A1, Jul. 27, 2006.
Patent Document 2: Paik, Eun-kyoung, et. al., “Method for optimizing synchronization signal among multiple home agents in mobile Internet service system”, WIPO Patent No. WO06068439A1, Jun. 29, 2006.
Patent Document 3: Maeda, M., “Location registration using multiple care-of addresses”, US Patent No. US20040142657A1, Jul. 22, 2004.
Patent Document 4: Vesterinen, S., “Local mobility management in mobile internet protocol network”, US Patent No. US20060209759A1, Sep. 21, 2006.
Patent Document 5: Ikeda, S., et. al., “Mobility managing method and mobile Terminal”, WIPO Patent No. WO04014027A2, Feb. 12, 2004.
Patent Document 6: White, P., et. al., “Multi access terminal with capability for simultaneous connectivity to multiple communication channels”, WIPO Patent No. WO06055784A2, May 26, 2006.
Patent Document 7: Wall, S. B., et. al., “System and method for handoff processing”, U.S. Pat. No. 7,272,123, Sep. 18, 2007.
Patent Document 8: Karia, S., et. al., “Reducing data loss during handoffs in wireless”, WIPO Patent No. WO2007041652A2, Apr. 12, 2007.
Patent Document 9: Bachmann, J., et. al., “Enabling simultaneous use of home network and foreign network by a multihomed mobile node”, WIPO Patent No. WO2007039016A1, Apr. 12, 2007.
Patent Document 10: Weniger, K., et. al., “Race condition resolution in mixed network- and host-based mobility management scenarios”, European Patent No. EP1953991A1, Aug. 6, 2008.

### Non-Patent Document

Non-Patent Document 1: Johnson, D. B., Perkins, C. E., and Arkko, J., “Mobility Support in IPv6”, Internet Engineering Task Force Request For Comments 3775, June 2004.
Non-Patent Document 2: Gundavelli, S., et. al., “Proxy Mobile IPv6”, Internet Engineering Task Force (IETF) Working Group Draft: draft-sgundave-mip6-proxymip6-02.txt, Mar. 5, 2007.
Non-Patent Document 3: “3GPP System Architecture Evolution: Report on Technical Options and Conclusion”, 3GPP TR 23.882, V1.12.0, October 2007.
Non-Patent Document 4: Wakikawa, R., et. al., “Multiple Care-of Addresses Registration”, Internet Engineering Task Force Working Group Draft: draft-ietf-monami6-multiplecoa-03.txt, January 2008.
Non-Patent Document 5: Gundavelli, S., et. al., “Proxy Mobile IPv6”, Internet Engineering Task Force (IETF) Internet Engineering Task Force Request For Comments 5213, August 2008.
Non-Patent Document 6: “3rd Generation Partnership Project; Technical Specification Group Services and System Aspects; Architecture enhancements for non-3GPP accesses”, 3GPP TS 23.402, V8.3.0, September 2008.
Non-Patent Document 7: Wakikawa, et. al., “Multiple care-of addresses Registration”, Internet Engineering Task Force Draft: draft-ietf-monami6-multiplecoa-10.txt, November 2008.

The following describes a problem in the case where a MN refers to a home prefix and a foreign prefix from the same home LMA/HA and tries to achieve reachability of an interface referring to the foreign prefix. In an example of FIG. 14, communication between a plurality of interfaces of a MN 200 and a CN 214 is firstly conducted via a LMA/HA/home Packet Data Network (PDN) gateway 203 of a home PMIPv6 network 204 as a 3GPP network and a MAG/3G serving gateway (S-GW) 201 (and the Internet 205). Next, when one of the plurality of interfaces of the MN 200 connects with an access router (AR) 207 of a network 206, communication between the plurality of interfaces of the MN 200 and the CN 214 is performed via the LMA/HA/home PDN gateway 203 of the home PMIPv6 network 204 and a MAG/ePDG (evolved Packet Data Gateway) 202 (and the Internet 205). A network with which the MN 200 newly connects is an Untrusted access network, which is a WLAN 206, for example.

In the exemplary system illustrated in FIG. 14, PMIPv6 registration and CMIPv6 registration of the MN 200 are generated at the LMA/HA/home PDN gateway 203. Directing attention to a basic operation assumed at the LMA/HA/home PDN gateway 203, firstly, a different prefix is assigned to each of the plurality of interfaces of the MN 200, whereby the LMA/HA/home PDN gateway 203 maintains individual PMIPv6 caches (a first entry E1 and a second entry E2 in a binding cache 213) with different prefixes relating to the respective interfaces of the MN 200.

Next, as for the CMIPv6 cache, when a different HoA is allocated to each interface of the MN 200, the LMA/HA/home PDN gateway 203 separately manages a CMIPv6 cache relating to each HoA, or when a common HoA is allocated to all interfaces as disclosed in Non-Patent Document 4, the LMA/HA/home PDN gateway 203 uses a BID so as to distinguish each interface associated with the one CMIPv6 cache. A third entry E3 of the binding cache 213 illustrated in FIG. 14 configures a CMIPv6 cache where an address created from P1 is a HoA and an address created from P2 is a CoA. Assume herein that since the PMIPv6 protocol uses a plurality of prefixes, a certain PMIPv6 cache (the first entry E1) has a HoA created from the same prefix and simply can be replaced with a CMIPv6 binding without a BID or an interface identifier. Basically, assume that in the case where a PMIPv6 cache is updated with a CMIPv6 cache or in the reverse situation, the BID/interface identifier is not a major parameter. For instance, in the case where a PMIPv6 cache has the same BID/interface identifier as that of a CMIPv6 registration request but prefixes of the PMIPv6 registration and the CMIPv6 registration are different, the PMIPv6 registration and the CMIPv6 registration are not mutually overwritten and exist in parallel with each other.

This operation will be evident from the following specific example. In FIG. 14, assume that a 3G cellular interface If1 of the MN 200 is attached to the MAG/3G S-GW (serving gateway) 201, and a WLAN interface If2 of the MN 200 is attached to the MAG/ePDG 202. Assume further that the WLAN interface If2 of the MN 200 is directly attached to the AR 207, and is attached to the MAG/ePDG 202 via an IPsec tunnel interface. Basically, the MAG/ePDG 202 is a trusted gateway with respect to the home PMIPv6 network 204 (hereinafter a home PMIPv6 domain) as a 3GPP network. Further, the WLAN 206 is connected with the Internet 205 and the home PMIPv6 network 204 also is connected with the Internet 205.

The MN 200 acquires a prefix from the LMA/HA/home PDN gateway 203 and creates an address. However, the MN 200 configures another address for the WLAN interface If2. Such an address is a not-invariant address where a prefix directly relates to a prefix of the AR 207. This not-invariable address is used only for tunneling of a packet to the MAG/ePDG 202.

When the 3G cellular interface If1 of the MN 200 is firstly attached to the home PMIPv6 network 204 and succeeds in access authentication at layer 2, the MAG (MAG/3G S-GW) 201 executes a PBU/PBA operation (signaling 208 of the drawing) with the LMA/HA/home PDN gateway 203, and the LMA/HA/home PDN gateway 203 assigns a home prefix P1 with the PBA message (208). The PMIPv6 registration at the LMA/HA/home PDN gateway 203 relating to the MN 200 at this time is the first entry E1 in the binding cache (BC) 213. In this first entry E1, a home prefix P1, an address MAG1 of the MAG/3G serving gateway 201 as a MAG address, a NAI as an MN-ID, and If1-ID as If-ID are associated. The detailed description thereof is omitted because Non-Patent Document 2 describes this.

Next, when the WLAN interface If2 of the MN 200 is attached to the WLAN domain 206, the MN 200 firstly acquires a not-invariant address, i.e., configures a not-invariant address from the prefix of the AR 207, and then executes a domain name server (DNS) query to acquire an ePDG address. After acquiring the ePDG address, the MN 200 starts an Internet key exchange (IKEv2) procedure with the MAG/ePDG 202 to establish a secure tunnel. During the tunnel establishment procedure, an authentication parameter at layer 3 is transferred, and when the authentication succeeds, the MAG/ePDG 202 exchanges a PBU/PBA message (signaling 209 of the drawing) with the LMA/HA/home PDN gateway 203, so that a prefix P2 used for a local prefix (foreign prefix) for the home prefix P1 is acquired and is transferred to the MN 202 (signaling 211 of the drawing). The signaling 211 indicates an IPsec tunnel establishment acknowledgement message. Registration created in the BC 213 with the PBU/PBA message (signaling 209 of the drawing) is the second entry E2. In the second entry E2, a foreign prefix P2, an address MAG2 of the MAG/ePDG 202 as a MAG address, a NAI as an MN-ID, and If2-ID as If-ID are associated. Herein, the prefix P1 is called a home prefix and the prefix P2 is called a foreign prefix, which is based on a relationship between HoA and CoA in the entry E3. Therefore, when communication is conducted with a CN using the prefix P2, the prefix P2 is regarded as a home prefix and the prefix P1 is regarded as a foreign prefix.

The following considers the case where when the MN 200 refers to the foreign prefix P2 via the WLAN interface If2, the MN 200 wants to acquire a multihoming function by transmitting the CMIPv6 registration, which is transmitted for simultaneous attachment from the home network and the foreign network described in Non-Patent Document 4, via the WLAN interface If2 so as to achieve reachability. Herein, this CMIPv6 registration message includes information (HoA (P1) and CoA (P2)) to create the entry E3. However, in order not to make the existing entry E1 relating to the same prefix P1 invalid, information (set flag H, or BID for E3 different from BID for E1) indicating to create E3 independent of E1 is included. When all of the interfaces of the MN 202 are used like this, the band thereof is broadened, so that QoS of several flows of the MN 202 can be enhanced. The MN 200 may want these flows to reach only via the WLAN interface If2. In this case, CMIPv6 registration 212 with flag H is transmitted to make a filter rule appropriate so that a certain flow from the CN 214 reaches only via the WLAN interface If2. The detailed description of the flag H is omitted because Non-Patent Document 4 describes this.

When the MN 200 executes the CMIPv6 registration 212 with flag H, the third entry E3 is created in the binding cache 213. In the third entry E3, HoA created from the home prefix P1, CoA (P2) created from the foreign prefix P2 as a CoA, a NAI as an MN-ID, and flag H as If-ID are associated. Herein, it is important how the third entry E3 is maintained. Note here that the flag H is used to create an entry indicating connections with both of home and away at the home agent. The LMA/HA/home PDN gateway 203 accepts the CMIPv6 registration 212 with the flag H existing therein and creates a CMIPv6 entry as the third entry E3. The third entry E3 does not overwrite the first entry E1.

If the MN 200 transmits CMIPv6 BU with the interface identifier If1-ID added thereto (i.e., BID=If1-ID), this CMIPv6BU will overwrite the first PMIPv6 entry E1, thus leading to the loss of multihoming function. Thus, the MN 200 should be able to transmit the CMIPv6 registration 212 with BID or flag H, and this BID should be different from the interface identifier If1-ID so as to prevent the first PMIPv6 entry E1 from being overwritten by the CMIPv6 registration 212. Herein, it is important that when the MN 200 transmits CMIPv6 registration equal to the interface identifier If2-ID, the second PMIPv6 entry E2 is not overwritten by this CMIPv6 registration. This is because the PMIPv6 protocol adopts a unique prefix to each interface, and therefore a PMIPv6 cache is replaced with a CMIPv6 cache only when a prefix of the PMIPv6 cache agrees with a prefix of a home address of a new CMIPv6BU message.

Referring now to the entries E1, E2 and E3 in the BC 213, it is evident that CMIPv6 registration directly relates to the second entry E2. It is further evident for those skilled in the art that the LMA/HA/home PDN gateway 203 has to check whether the prefix P2 includes PMIPv6 registration or not in the binding cache 213 so as to route a packet addressed to CoA (P2) created when the entry E3 is used. In order to precisely route a packet to the WLAN interface WLAN interface If2, such regressive tracing is required. The LMA/HA/home PDN gateway 203 can route a packet to CoA (P2) correctly only when the address MAG2 of the MAG 202 is found.

It is important that all packets addressed to the MN 200 reach one HoA created from the prefix P1. The LMA/HA/home PDN gateway 203 basically uses the first entry E1 (PMIPv6 entry) or the third entry E3 (CMIPv6 entry) to route a packet addressed to the HoA. Based on the above description, it is understood that a CMIPv6 binding cache (third entry E3) is very static on the assumption that the contents of the CMIPv6 cache is not changed. Thus, the present invention provides a mechanism to optimize signaling to create the CMIPv6 entry E3.

A method disclosed in Patent Document 1 examines a problem occurring when a dynamic roaming service agreement is created. In this method, a multimode terminal (MMT) attached to a foreign network is discovered by a home network using a parameter provided by the MMT. This parameter is acquired via an interface of the MMT externally connecting. The home network uses a foreign network identifier given by the MMT to create a dynamic roaming agreement. Signaling by this MMT does not have to be continuous. The MMT may provide cell location data such as a network type, an operator code, and SSID (Service Set IDentifier) of WLAN or information on SSID of a base station. The home network basically identifies a parameter of a foreign network based on these data and creates fly agreement.

The method described in Patent Document 1 does not deal with signaling optimization described referring to FIG. 14, which however provides, to a home network, information on a foreign network using an interface connecting with the foreign network. This information is provided only once, but has nothing to do with creation of a binding entry in the home network.

Patent Document 2 discloses a method to cope with a problem when signaling is synchronized among a plurality of HAs in a home network. In terms of load balancing, it is effective to use a plurality of HAs in a home network. In order to prepare for error occurrence or in order to adapt a system to dynamic load balancing, a binding cache entry (BCE) of one HA is stored in another HA as well. However, while the MN is in an idle state, there is no need to store a BCE in all HAs. In the method disclosed in Patent Document 2, when a MN transmits a BU message to a HA, information indicating whether the MN is in an active state or in an idle state is transmitted together. This information is used to synchronize signaling among a plurality of HAs. When the MN shifts to an active state, a BU message including this information is transmitted to all HAs. Whereas, unless the MN shifts to an active state, this information is not transmitted to all HAs. This method copes with the signaling storm problem described referring to FIG. 14, but is different from the present invention. That is, in Patent Document 2, information indicating whether the MN is in an active state or in an idle state is provided, but information on interface binding to create a BCE in the HA is not provided.

Patent Document 3 discloses a system where a MN includes a plurality of interfaces, and when all interfaces connect with a foreign network and binding update is performed for HA and CN. When a MN includes a plurality of interfaces and position registration is transmitted to all peer entities, signaling load will increase. In Patent Document 3, in order to reduce signaling load, a MN updates a certain CoA for HA, and updates another CoA for CN. According to this method, signaling efficiency can be achieved. However, the MN makes a smart decision to reduce signaling load due to the MN, but the MN has to transmit a BU message continuously. A problem to be solved in FIG. 14 is to completely remove MN signaling during roaming in home PMIPv6.

Patent Document 4 discloses a method similar to PMIPv6 in Non-Patent Document 2. A network in Patent Document 4 includes an access router in a local mobility domain and a wireless access point connecting with this access router, where the wireless access point serves as a proxy of the MN. The access router in the local mobility domain keeps a proxy CoA of the MN, and when a packet addressed to the MN comes, the access router replaces the proxy CoA with a local address of the wireless access point. The local address of the wireless access point is invisible to the MN. This method can reduce signaling load relating to the MN, but cannot reduce signaling when a MN with a plurality of interfaces roams in a PMIPv6 domain.

As described above, in the conventional techniques, when a MN with a plurality of interfaces roams in a PMIPv6 domain with one home LMA/HA, signaling of CMIPv6 registration has to be transmitted so as to associate an address created from a prefix assigned to a certain interface with an address used for communication with CN so as to ensure reachability of a packet to the interface. However, in order to maintain a cache created by normal CMIPv6 registration, the MN has to transmit signaling to a HA regularly so as to update the cache. Further, when another address is obtained after moving, a registered cache has to be deleted or updated. These procedures increase traffic due to signaling that the MN transmits.

Next, attention is directed to the case where a MN with a plurality of interfaces registers a plurality of bindings with a core network to implement simultaneous connectivity via this plurality of interfaces. This problem relating to registration of a plurality of bindings to implement simultaneous connectivity has to be solved. This is because unnecessary signaling causes wasted consumption of battery power source of the MN, and increases signaling load for a wireless access network. The resource of the wireless network and a battery is limited, which has to be protected by avoiding unnecessary signaling.

This problem is notable when a MN with a plurality of interfaces is attached to a core network, where one interface is attached to a home link and another interface is attached to a foreign link. The home link is a link referring to a home prefix as described in Non-Patent Document 1, and the home prefix also is defined in Non-Patent Document 1. The home prefix is a prefix managed by a home agent, which is used to configure a MIPv6 home address of a MN.

A major reason of the problem concerning registration of a plurality of bindings results from delay in setup of a home path. The delay in setup of a home path is generated when mobility of the home prefix is managed by a PMIPv6 mechanism such as 3GPP. An operation of PMIPv6 mechanism in a local domain is described in Non-Patent Document 5. When the home link is not a 3GPP link, i.e., when the home link is not managed by 3GPP architecture or when mobility of the home prefix is not managed by PMIPv6, the MN may detect the home link speedily. However, the problem of delay in setup of a home path depends on an actual home link detection operation. Thus, the problem here is obviously applied to all networks where mobility of a home prefix is managed by a PMIPv6 mechanism and setup of a home link is delayed. This problem is described with reference to FIG. 15. It is obvious for those skilled in the art that this problem is applied also to the case where mobility of a home prefix is managed by GTP (generic Tunneling Protocol) mechanism.

Non-Patent Document 7 describes a mechanism where a MN with a plurality of interfaces can be located at a home link and a foreign link at the same time via these plurality of interfaces, and all of the interfaces can connected with a core network. In this mechanism, when the MN detects the home link via one interface and detects the foreign link via another interface, the MN transmits, via the foreign link, a MIPv6-BU message including a BID option with H flag indicating that the MN itself connects with the home link and the foreign link at the same time. This H flag provides, to the HA, information indicating that a packet addressed to the MN can reach both of the interfaces on the home side and on the foreign side. Receiving this information, the HA triggers a mechanism that captures a packet reaching a home address of the MN. A major assumption described in Non-Patent Document 7 is that a MN with a plurality of interfaces connects with a network via the plurality of interfaces in a foreign domain, where one of the interfaces returns to a home domain.

On the other hand, the following examines three cases of connection with a home link and a foreign link at the same time that Non-Patent Document 7 does not cover at all. As a first case, there is a case where when a MN boots up both interfaces at the same time, one of the interfaces is connected with a home link. As a second case, there is a case where a MN is connected with a foreign link and includes one interface during handoff, and the MN boots up another interface capable of connecting with a home link. As a third case, there is a case where a handoff is generated at both interfaces at the same time, where one of the interfaces refers to a home prefix and the other interface refers to a foreign prefix. FIG. 15 illustrates this.

In FIG. 15, a MN 903 may include, as a plurality of different types of interfaces, a Non-3GPP interface such as WLAN or WiMAX as well as a 3GPP interface such as UTRAN (Universal Terrestrial Radio Access Network), GPRS (General Packet Radio Service), CDMA (Code Division Multiple Access) 2000 or E-UTRAN (evolved-UTRAN). Assume herein that the MN 903 includes two interfaces of a 3G interface and a Non-3GPP interface. When the MN 903 is attached to a WiMAX access network 901, a MAG function of the network conceivably coexists with an access gateway located in a wireless access network. When the MN 903 includes a WLAN interface as a Non 3GPP interface and is attached to an Untrusted WLAN access network, a MAG function of the network conceivably coexists with an ePDG (evolved Packet Data network Gateway). Further, when the MN 903 is attached to a 3G access network such as E-UTRAN, UTRAN, or GERAN, for example, a MAG function of the network conceivably coexists with S-GW (Serving Gateway). Further, when the MN 903 is in 3GPP architecture, a LMA/HA function conceivably coexists with a P-GW (Packet data network GateWay).

In FIG. 15, assume that the MN 903 uses two interfaces of If1 and If2 only. To implement simultaneous attachment of the two interfaces If1 and If2, a WiMAX interface (herein called a Non3G interface) If2 and a LTE (Long-Term Evolution) type interface (herein called a 3G interface) If1 are used. It is, however, obvious that the MN 903 can use other types of interfaces for simultaneous attachment, and it is also applicable to an interface that might be used in a 3GPP standard. The present invention is further applicable to a network using similar architecture and mobility protocol.

In the following first assumption, the MN 903 firstly turns on a power source of the WiMAX interface If2 only, and after a lapse of certain time duration, the MN 903 turns on a power source of the 3G interface If1 for advantages of load balancing and of load sharing. Assume herein that the MN 903 turns on a power source of the WiMAX interface If2 only in a foreign network (e.g., VPLMN, Visited Public Land Mobile Network). Assume further that the MN 903 uses a MIPv6 mechanism to manage mobility of the WiMAX interface If2. Assume that the MN 903 thereafter returns to EPC 900 as a home domain while leaving the power source of the WiMAX interface If2 turned on. In this case, when the MN 903 moves to a HPLMN (Home Public Land Mobile Network) as the EPC 900, for example, the MN 903 conceivably turns on a power source of the LTE interface If1. There are many reasons for turning on the power source of the LTE interface If1, for example, a LTE cell is identified in the HPLMN 900, and a decision is made to achieve advantages of load balancing and of load sharing so as to improve performance of the flow.

Assume that the MN 903 moves to the HPLMN 900, i.e., the EPC (evolved packet core) 900 and connects the WiMAX interface If2 with the MAG 911, thus being attached to the EPC 900. Assume that mobility of the WiMAX interface If2 is managed by a MIPv6 mechanism in the home domain 900. Assume further that the WiMAX interface If2 is conducting handoff processing from a VPLMN to the HPLMN 900. When the MN 903 is attached to the MAG 911 via the WiMAX access network 901, the MN 903 starts attachment processing to a LTE (or E-UTRAN) access network 902 via the LTE interface If1. Further, mobility of the LTE interface If1 is managed by a PMIPv6 mechanism, and conceivably the usage of a MIPv6-BU message is extremely limited as described in Non-Patent Document 6.

Once access authentication of the MN 903 via the WiMAX interface If2 is completed, the MN 903 refers to a prefix P2 notified from the MAG 911. This prefix P2 is used to configure CoA of the WiMAX interface If2. The prefix P2 notified from the MAG 911 is advertised by the MAG 911 using a router advertisement (RA) mechanism or a signaling mechanism unique to WiMAX (prefix advertisement signaling message 905 in the drawing). The MN 903, referring to the message 905, configures CoA of the WiMAX interface If2 and transmits a MIPv6-BU message 906 to the LMA/HA 904 (BU1). In this case, the LMA/HA 904 serves as a home agent of the MN 903. The MIPv6-BU message 906 becomes a normal message without BID option and H flag. This operation is a normal operation for a MN operating in MIPv6.

The MIPv6-BU message 906 does not have a parameter such as H flag meaning multihoming because the MN 903 starts attachment processing to the LTE access network 902, but does not yet refer to the home prefix P1. In this case, delay occurs in the LTE access until setup of PMIPv6 bearer or GTP (Generic Tunneling Protocol) bearer is completed. One of the reasons for this delay is extreme congestion, another reason is delay in path transfer via a home link due to geographical arrangement, and still another reason is delay caused by a packet passing through many entities (e.g., a base station, an evolved node B, and a S-GW) in E-UTRAN. Therefore, the MN 903 does not find a type (i.e., whether it is a MIPv6 home prefix or another home network prefix) of the prefix P1 referred to by via the LTE access. As a result, the MN 903 is attached via WiMAX, and transmits a BU message 906 without a parameter meaning multihoming so as to transmit/receive a flow relating to the MIPv6 home prefix.

It is important why the MN 903 does not find a type of the prefix P1 advertised via the LTE interface If1. As described in Non-Patent Document 6, the MN 903 finds a service type only acquired via the LTE interface If1. The LMA/HA 904 performs prefix management and already makes a notification of the MIPv6 prefix via the WiMAX interface If2, and therefore any prefix can be assigned to the PMIPv6 bearer.

Next assume that the MN 903 is attached to the LTE access network 902, and thereafter triggers the MAG 910 for setup of the PMIPv6 bearer. This PMIPv6 bearer for data traffic is set up by a PMIPv6-PBU message 907. When exchange of the PMIPv6-PBU message 907 and a PBA message thereof (not illustrated) is completed, the MN 903 refers to the prefix P1 managed by the LMA/HA 904 with a message 908 from the MAG 910. The prefix P1 referred to with the message 908 is managed by a PMIPv6 mechanism. However, the prefix P1 referred to with the message 908 may be a MIPv6-home prefix of the MN 903 or may be a certain home network prefix managed by the LMA/HA 904. Further, since the LMA/HA 904 manages both of a MIPv6 cache and a PMIPv6 cache, the use of a binding cache created by the PMIPv6-PBU message 907 is stopped (not active). This is because the MIPv6 cache created by the LMA/HA 904 has been already active. Assume herein that the priority of the MIPv6 cache is higher than that of the PMIPv6 cache.

The following considers the case where when the MN 903 is attached via the LTE interface If1, the LMA/HA 904 gives a MIPv6 home prefix P1. The MN 903, referring to the MIPv6 home prefix P1 with the message 908, finds the connection with a home link. Further, when the MN 903 refers to a prefix P2 with a message 905 and thereafter refers to a home prefix P1 later with a message 908, the MN 903 understands the connection with a home link and a foreign link at the same time. That is, the MN 903, referring to the home prefix P1, has to transmit another BU message 909 to the LMA/HA 904 (BU2) and create simultaneous binding of the home link and the foreign link (hereinafter called home and away binding) in the LMA/HA 904. This is important because the LMA/HA 904 needs information on the simultaneous connection of the MN 903 with the home link and the foreign link so as to achieve load sharing and load balancing of a flow. Therefore, an important issue herein is that a MIPv6-BU message is transmitted doubly to allow the MN 903 to implement simultaneous connection for the MIPv6-home prefix P1 because of delay in setup of PMIPv6 (BU1 and BU2 in the drawing).

That is a description on the problems on assumed specific examples. However, it is obvious for those skilled in the art that the above-stated problems will occur also when power sources of both of the interfaces If1 and If2 of the MN 903 are turned on simultaneously or when both of the interfaces If1 and If2 move simultaneously. The above problems are described on the simultaneous attachment in HPLMN. However, such problems will occur also when both of the interfaces If1 and If2 of the MN 903 connect with VPLMN simultaneously, and mobility of the 3G interface or of the LTE interface If1 is managed by the PMIPv6 mechanism. Further, the above problems will occur also when the LTE interface If1 connects with VPLMN and the WiMAX interface If2 connects with HPLMN.

Patent Document 5 describes a method where a MN located in a foreign domain configures a second HA to acquire a new home address. The MN further uses this home address to bind a previous HA in the home domain so as to reduce BU signaling passing through the foreign domain. An object of the method described in Patent Document 5 is to reduce position management singling passing through the foreign domain. This method, however, does not relate to the signaling problem described in FIG. 15. The MN 903 in FIG. 15 performs double signaling (BU1 and BU2 in the drawing) to manage mobility of simultaneous connection when both of the interfaces If1 and If2 move simultaneously.

Patent Document 6 discloses a method to establish a plurality of simultaneous connections and to use operating system software of a MN so as to establish flow-based routing. Patent Document 6, however, does not disclose a method to cope with the problem described in FIG. 15.

Patent Document 7 discloses a method to establish a high-speed handoff by acquiring context information on a MN from an adjacent base station prior to handoff and not by transferring context information during handoff, and high-speed handoff can be implemented by acquiring the context information on the MN prior to handoff. This method, however, increases signaling load released to a network segment. This is because a network entity as a target makes an inquiry to a plurality of base stations to acquire context information on the MN and implement a high-speed handoff. The problem targeted in FIG. 15 is to prevent unnecessary signaling so as to implement high-speed connection with the WiMAX interface If2 and the 3G interface If1. The method described in Patent Document 7 deals with establishing of high-speed connection with only one interface, which does not cope with the problem targeted in FIG. 15.

Patent Document 8 discloses a method to reduce a packet loss during a handoff using, a buffering technique. Patent Document 8, however, does not direct attention to establish high-speed connection nor to reduce handoff delay of a terminal with a plurality of interfaces with less signaling.

Patent Document 9 discloses a method where a MN uses a CoA of an interface connecting with home so as to implement home and away registration simultaneously. Patent Document 9, however, does not deal with H flag indicating home and away directly, and does not provide any mechanism to implement setup of a high-speed connection with consideration given to delay in setup of PMIPv6.

Patent Document 10 discloses a method to deal with race between PMIPv6-BU and CMIPv6-BU for one interface. However, the problem described in FIG. 15 does not result from the race of position registration signals of the same interface, but from delay in BU establishment of PMIPv6 than BU-establishment of MIPv6, thus causing double reservation (BU1 and BU2 in the drawing) during attachment of the plurality of interfaces If1 and If2. Thus, the solution provided by Patent Document 10 does not cope with the problem described in FIG. 15.

### SUMMARY OF THE INVENTION

In view of the above-stated problems, it is a first object of the present invention to provide a binding cache creating method, a binding cache creating system, a home agent, and a mobile node by which, when a mobile node with a plurality of interfaces roams in a home domain, signaling to create a client-based binding cache in a home agent and manage the same can be reduced.

It is a second object of the present invention to provide a binding cache creating method, a binding cache creating system, a home agent, and a mobile node by which, signaling for binding registration can be reduced when a mobile node with a plurality of interfaces connects with a home link and a foreign link simultaneously.

In order to fulfill the above first object, a binding cache creating method of the present invention, when a mobile node with a first interface capable of communicating with a home domain and a second interface capable of communicating with a local domain roams in the home domain, includes the steps of:

a step of, when the first interface of the mobile node is attached to the home domain, registering a first proxy binding cache for the first interface with a home agent of the home domain;

a step of, when the second interface of the mobile node is attached to the home domain via the local domain, registering a second proxy binding cache for the second interface with the home agent; and

a step where the home agent creates a client-based binding cache for the second interface relating to the first and the second proxy binding caches and maintains the created client-based binding cache without being refreshed by the mobile node.

In order to fulfill the above first object, a binding cache creating system of the present invention, when a mobile node with a first interface capable of communicating with a home domain and a second interface capable of communicating with a local domain roams in the home domain, includes:

means that, when the first interface of the mobile node is attached to the home domain, registers a first proxy binding cache for the first interface with a home agent of the home domain;

means that, when the second interface of the mobile node is attached to the home domain via the local domain, registers a second proxy binding cache for the second interface with the home agent; and

means that makes the home agent create a client-based binding cache for the second interface relating to the first and the second proxy binding caches and maintain the created client-based binding cache without being refreshed by the mobile node.

With the above configurations, when a mobile node with a plurality of interfaces roams in a home domain, the mobile node does not transmit a request message to refresh a client-based binding cache in a home agent frequently, so that signaling can be reduced.

In order to fulfill the above first object, a home agent in a binding cache creating system of the present invention, when a mobile node with a first interface capable of communicating with a home domain and a second interface capable of communicating with a local domain roams in the home domain, includes:

means that, when the first interface of the mobile node is attached to the home domain, registers a first proxy binding cache for the first interface;

means that, when the second interface of the mobile node is attached to the home domain via the local domain, registers a second proxy binding cache for the second interface; and

means that creates a client-based binding cache for the second interface relating to the first and the second proxy binding caches and maintains the created client-based binding cache without being refreshed by the mobile node.

In order to fulfill the above first object, a mobile node of the present invention in a binding cache creating system, the mobile node including a first interface capable of communicating with a home domain and a second interface capable of communicating with a local domain, and the mobile node roaming in the home domain, includes:

means that, when a first proxy binding cache for the first interface is registered with a home agent of the home domain, transmits a request message to the home agent, the request message requesting to create a client-based binding cache for the second interface relating to first and second proxy binding caches for the first and the second interfaces and maintain the client-based binding cache.

In order to fulfill the above first object, a home agent of the present invention of a home domain in a binding cache creating system, when a mobile node with a first interface capable of communicating with the home domain and a second interface capable of communicating with a local domain roams in the home domain, and when a first proxy binding cache for the first interface is registered with the home agent, the mobile node transmits a request message to the home agent, the request message requesting to create a client-based binding cache for the second interface relating to first and second proxy binding caches for the first and the second interfaces and maintain the client-based binding cache, includes:

means that, after receiving the request message and when a second proxy binding cache for the second interface is registered, creates a client-based binding cache for the second interface relating to the first and the registered second proxy binding caches, and notifies the mobile node so as not transmit the request message again.

In order to fulfill the above first object, a binding cache creating method of the present invention, when a mobile node with a first interface capable of communicating with a home domain and a second interface capable of communicating with a local domain roams in the home domain, includes the steps of:

a step of, when the first interface of the mobile node is attached to the home domain, registering a first proxy binding cache for the first interface with a home agent of the home domain;

a step of, when the second interface of the mobile node is attached to the home domain via the local domain, registering a second proxy binding cache for the second interface with the home agent; and

a step where the mobile node requests the home agent to create a client-based binding cache for the second interface relating to the first and the second proxy binding caches and maintain the created client-based binding cache without being refreshed by the mobile node for duration longer than a usual time period.

In order to fulfill the above first object, a binding cache creating method of the present invention, when a mobile node with a first interface capable of communicating with a home domain and a second interface capable of communicating with a local domain roams in the home domain, includes the steps of:

a step of, when the first interface of the mobile node is attached to the home domain, registering a first proxy binding cache for the first interface with a home agent of the home domain;

a step of, when the second interface of the mobile node is attached to the home domain via the local domain, registering a second proxy binding cache for the second interface with the home agent;

a step where the mobile node requests the home agent to create a client-based binding cache for the second interface relating to the first and the second proxy binding caches registered with the home agent; and

a step where the home agent creates the requested client-based binding cache and sets duration longer than a usual time period thereto, while notifying the mobile node so as not to refresh the created client-based binding cache for the duration.

In order to fulfill the above first object, a binding cache creating method of the present invention, when a mobile node with a first interface capable of communicating with a home domain and a second interface capable of communicating with a local domain roams in the home domain, includes the steps of:

a step of, when the first interface of the mobile node is attached to the home domain, registering a first proxy binding cache for the first interface with a home agent of the home domain;

a step of, when the second interface of the mobile node is attached to the home domain via the local domain, registering a second proxy binding cache for the second interface with the home agent; and

a step where when the second proxy binding cache for the second interface is registered, the home agent notifies the mobile node so as not to transmit a request to create a client-based binding cache for the second interface, while executing client-based routing relating to the first and the second proxy binding caches.

In order to fulfill the above second object, a binding cache creating method of the present invention for, when a mobile node with a first interface capable of communicating with a home domain and a second interface capable of communicating with a local domain roams, creating binding caches for the first and the second interfaces in a home agent of the mobile node, includes the steps of:

a step where, when the second interface is attached to the home domain via the local domain, the mobile node makes a request to the home agent to register a client-based binding cache for the second interface and to set a flag indicating simultaneous attachment of home and away in the client-based binding cache for the second interface when a proxy binding cache for the first interface is registered;

a step where, when the first interface is attached to the home domain, a proxy node of the mobile node registers the proxy binding cache for the first interface with the home agent; and

a step where, when the proxy binding cache for the first interface is registered, the home agent sets the flag in the client-based binding cache for the second interface.

In order to fulfill the above second object, a binding cache creating system of the present invention, when a mobile node with a first interface capable of communicating with a home domain and a second interface capable of communicating with a local domain roams, binding caches for the first and the second interfaces are created in a home agent of the mobile node, includes:

means that, when the second interface is attached to the home domain via the local domain, makes the mobile node make a request to the home agent to register a client-based binding cache for the second interface and to set a flag indicating simultaneous attachment of home and away in the client-based binding cache for the second interface when a proxy binding cache for the first interface is registered;

means that, when the first interface is attached to the home domain, makes a proxy node of the mobile node register the proxy binding cache for the first interface with the home agent; and

means that, when the proxy binding cache for the first interface is registered, makes the home agent set the flag indicating simultaneous attachment of home and away in the client-based binding cache for the second interface.

In order to fulfill the above second object, a mobile node of the present invention is in a binding cache creating system, the mobile node including a first interface capable of communicating with a home domain and a second interface capable of communicating with a local domain. When the mobile node roams, binding caches for the first and the second interfaces are created in a home agent of the mobile node. The mobile node includes:

means that, when the second interface is attached to the home domain via the local domain, makes a request to the home agent to register a client-based binding cache for the second interface and to set a flag indicating simultaneous attachment of home and away in the client-based binding cache for the second interface when a proxy binding cache for the first interface is registered.

In order to fulfill the above second object, a home agent of the present invention is in a mobile node in a binding cache creating system. When the mobile node with a first interface capable of communicating with a home domain and a second interface capable of communicating with a local domain roams, binding caches for the first and the second interfaces are created in the home agent. The home agent includes:

means that, when the second interface is attached to the home domain via the local domain, receives a request to register a client-based binding cache for the second interface and to set a flag indicating simultaneous attachment of home and away in the client-based binding cache for the second interface when a proxy binding cache for the first interface is registered;

means that, when the first interface is attached to the home domain, registers the proxy binding cache for the first interface; and

means that, when the proxy binding cache for the first interface is registered, sets the flag indicating simultaneous attachment of home and away in the client-based binding cache for the second interface.

With the above configurations, the mobile node does not transmit a second registration message including a flag indicating simultaneous attachment of home and away to the home agent, and therefore signaling for binding registration can be reduced when a mobile node with a plurality of interfaces connects with a home link and a foreign link simultaneously.

According to the present invention, when a mobile node with a plurality of interfaces roams in a home domain, signaling to create a client-based binding cache in a home agent and manage the same can be reduced.

According to the present invention, signaling for binding registration can be reduced when a mobile node with a plurality of interfaces connects with a home link and a foreign link simultaneously.

### BRIEF DESCRIPTION OF THE DRAWINGS

FIG. 1 illustrates a configuration of a communication system assumed in Embodiment 1.

FIG. 2 illustrates a configuration of another communication system assumed in Embodiment 1.

FIG. 3 describes a communication sequence of a communication method and a communication system in Embodiment 1.

FIG. 4 describes a configuration of a binding cache in a home agent of Embodiment 1.

FIG. 5 describes another embodiment of a CMIPv6 cache creation•maintenance/management request message in FIG. 3.

FIG. 6A describes a format of a CMIPv6 cache creation•maintenance/management request message (in the case of a L2 message) in FIG. 3.

FIG. 6B describes a format of a CMIPv6 cache creation•maintenance/management request message (in the case of a signaling packet with a new mobility extension header) in FIG. 3.

FIG. 6C describes a format of a CMIPv6 cache creation•maintenance/management request message (in the case of a packet of a BU message) in FIG. 3.

FIG. 7 is a flowchart to describe an operation by a mobile node in Embodiment 1.

FIG. 8 is a flowchart to describe an operation by a home agent in Embodiment 1.

FIG. 9 is a block diagram functionally illustrating a configuration of a mobile node in Embodiment 1.

FIG. 10 is a block diagram functionally illustrating a configuration of a home agent in Embodiment 1.

FIG. 11 describes a communication system and a communication sequence in Embodiment 2.

FIG. 12 describes a communication system and a communication sequence in Embodiment 5.

FIG. 13 describes a communication system and a communication sequence in Embodiment 8.

FIG. 14 describes a problem to be solved by the present invention.

FIG. 15 describes an assumed system to describe a problem in Embodiment 9.

FIG. 16 describes an assumed system to describe Embodiment 9.

FIG. 17 describes a binding cache entry in Embodiment 9.

FIG. 18A describes a first example of a packet configuration in a H flag creation request message in Embodiment 9.

FIG. 18B describes a second example of a packet configuration in a H flag creation request message in Embodiment 9.

FIG. 18C describes a third example of a packet configuration in a H flag creation request message in Embodiment 9.

FIG. 18D describes a fourth example of a packet configuration in a H flag creation request message in Embodiment 9.

FIG. 19 is a block diagram functionally illustrating a configuration of a mobile node in Embodiment 9.

FIG. 20 is a flowchart to describe processing by a mobile node in Embodiment 9.

FIG. 21 is a flowchart to describe processing by a home agent in Embodiment 9.

FIG. 22 describes another assumed system to describe Embodiment 9.

FIG. 23 describes still another assumed system to describe Embodiment 9.

### BEST MODE FOR CARRYING OUT THE INVENTION

### Summary of Embodiment 1

Summarizing Embodiment 1, a MN with a plurality of interfaces refers to a home prefix via one interface, the MN determines that the interface is connecting with a home PMIPv6 domain where a LMA (hereinafter called a home LMA/HA) as a HA of the MN is located, and predicts that another interface will connect with the same home PMIPv6 domain from now. When the other interface connects with the same home PMIPv6 domain after such prediction, the MN requests the home LMA/HA to create CMIPv6 binding for the other interface referring to a foreign prefix and maintain/manage the binding. A major object of the present invention resides in that a MN acquires advantages of home and advantages of away at the same time for all of the interfaces referring to a foreign prefix in the home PMIPv6 domain, and that the MN does not continuously perform client-based BU registration to the home LMA/HA.

### <Assumed System>

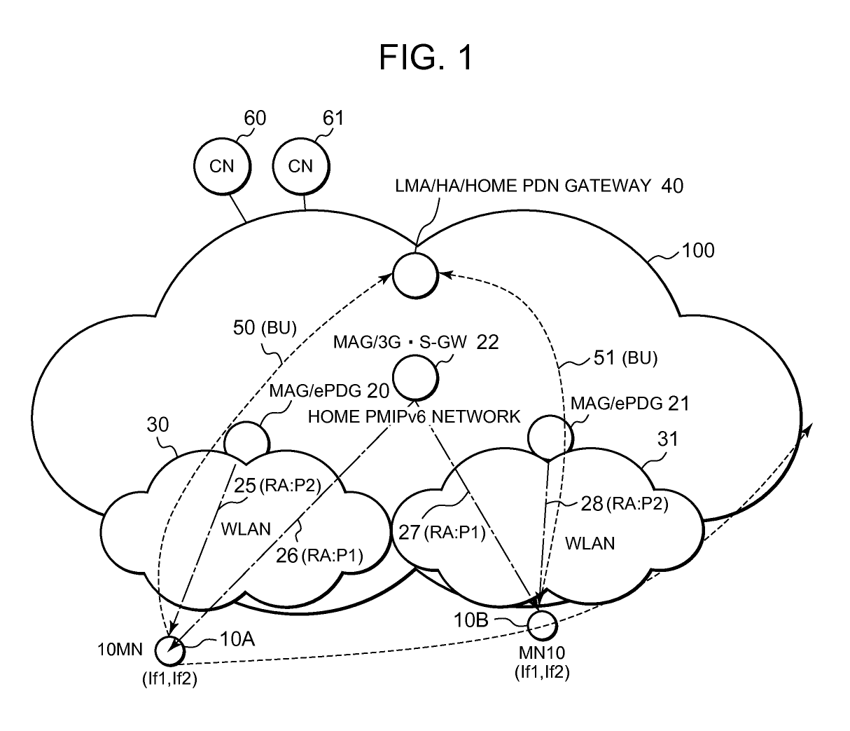

FIG. 1 illustrates a configuration of a communication system assumed in Embodiment 1. Herein, MNs 10A and 10B in FIG. 1 indicate the movement of one MN 10. The MN 10 includes a 3G cellular interface If1 and a WLAN interface If2 as a plurality of interfaces, and FIG. 1 illustrates a state where the MN 10A is located in a WLAN 30 and the WLAN interface If2 connects with a MAG/ePGD 20, and a state where the MN 10B is located in a WLAN 31 and the WLAN interface If2 connects with a MAG/ePDG 21. The plurality of interfaces of the MN 10 may be not only a cellular interface (cellular interface specified by a standardization organization concerning mobile phones of 3GPP such as 3G, 3.9G, 4G or later), WLAN interfaces specified by IEEE802 and WiFi but also a WiMAX interface and a Bluetooth interface. Hereinafter, a cellular interface is described as a 3G cellular interface and a serving gateway is described as a 3G service gateway, which are not limited to 3G although.

Meanwhile, the 3G cellular interface If1 is attached to one MAG/3G serving gateway (S-GW) 22 of a home PMIPv6 network (domain) 100, where the range of the home PMIPv6 network 100 is so large that the 3G cellular interface If1 can connect with one MAG 22 even when the MN 10 is located in the WLAN 30 or in the WLAN 31. The home PMIPv6 network 100 may be a 3GPP-HPLMN (Home Public Land Mobile Network) using a PMIPv6 protocol to provide a mobility management service in the network 100, for example, and is a home network domain of the MN 10. A LMN/HA/home PDN gateway 40 is a home agent (hereinafter called LMA/HA) of the MN 10.

The home PMIPv6 network 100 means that the LMA/HA 40 is a MIPv6-HA of the MN 10 and further the MN 10 refers to a prefix P1 of the network 100 as a MIPv6 home prefix when the MN 10 roams in the network 100. Basically, the LMA/HA 40 accepts PMIPv6 binding and MIPv6/CMIPv6 binding of the MN 10.

Next, a network layout of the home PMIPv6 network 100 is considered below. Although FIG. 1 describes only one network in the home PMIPv6 network 100, it is assumed that a lot of cellular access networks exist therein. Assume that a router equipped with a MAG function exists in the MAG/3G•S-GW 22 in the cellular access network, and this router is a first hop router in the 3G access network. Assume further that two WLANs 30 and 31 exist in a reception area of the 3G access network. Assume further that the WLANs 30 and 31 include MAG/ePDGs 20 and 21 as a gateway router and a trusted router for access to a 3GPP core network to transfer traffic via 3GPP architecture. Assume further that the WLANs 30 and 31 are contiguous (i.e., one being adjacent to the other) and exist under the control of a 3G cell (i.e., network 100) of a large area including a router function in the MAG/3G•S-GW (hereinafter simply called MAG) 22.

Assume herein that when the MN 10 firstly is attached to the WLAN 30 and the 3G network 100 as indicated with the MN 10A, and thereafter is attached to the WLAN 31 and the 3G network 100 as indicated with the MN 10B, the MN 10 always connects with the MAG/3G gateway 22 even during movement. Since the network 100 is the home PMIPv6 domain of the MN 10, assume that the MN 10 can surely refer to the home MIPv6 prefix P1 of the network 100 when being attached to the network 100. Since the LMA/HA 40 is equipped with a MIPv6 function, assume further that the home MIPv6 prefix P1 can be given to the MN 10 when a NAI of the MN 10 reaches the LMA/HA 40 with a PBU message. The home MIPv6 prefix P1 may be statically configured in the MN 10 beforehand or may be acquired by a dynamic mechanism such as bootstrapping mechanism.

Firstly, when the MN 10 is attached to the MAG 22 as a router of the network 100 via the 3G cellular interface If1, the MN 10 refers to the home MIPv6 prefix P1 as a prefix of the network 100 with a router advertisement (RA) message 26 from the MAG 22. Next, when the MN 10 connects with the MAG 20 as a router of the WLAN 30 via the WLAN interface If2, the MN 10 refers to the foreign prefix P2 as a prefix of the WLAN 30 with a RA message 25 from the MAG 20. Herein, it is important to understand the reason therefor. The reason is that according to the PMIP protocol disclosed in Non-Patent Document 2, a unique prefix is given to each interface so that the LMA/HA 40 gives the foreign prefix P2 to the WLAN interface If2. In the case where the MN 10 acquires a plurality of prefixes from the LMA/HA 40, a prefix used for communication with a CN may be called a home prefix and other prefixes may be called foreign prefixes.

Thus, the MN 10 has only one home prefix P1 and home address (HoA) for the 3G cellular interface If1 and the WLAN interface If2. In this case, when the MN 10 refers to the foreign prefix P2 via the second WLAN interface If2, the MN 10 conventionally executes CMIPv6 registration 50 to the LMA/HA 40 so as to acquire reachability to the WLAN interface If2. The CMIPv6 registration 50 means that the MN 10 binds a care-of address (CoA) created from the foreign prefix P2 with the HoA created from the home MIPv6 prefix P1.

Further, in the case where the MN 10 is equipped with a multihoming function described in Non-Patent Document 4, assume that home registration and away registration are performed at the same time by the CMIPv6 registration 50 with H flag set therein. Assume further that the LMA/HA 40 is equipped with a multihoming function described in Non-Patent Document 4. Additionally assume that the MN 10 is in communication with a plurality of CNs 60 and 61 located in another packet data network (PDN), and wants to communicate with the CNs 60 and 61 by selecting a local address in the PMIPv6 domain.

Assume that thereafter the MN 10 roams into the WLAN 31 (MN 11B in the drawing), and the MN 10 refers to the same foreign prefix P2 in a RA message 28 from the MAG 21 via the WLAN interface If2. Assume herein that a horizontal handoff occurs that is a handover between interfaces. If the duration of CMIPv6 expires when the MN 10 reaches the WLAN 31, in order to secure the reachablity to the WLAN interface If2 again or to acquire the simultaneous use of both of the interfaces If1 and If2, or if transfer to the WLAN interface If2 only is wanted, the MN 10 conventionally has to transmit a CMIPv6 BU message 51 with flag H or without flag H to the LMA/HA 40.

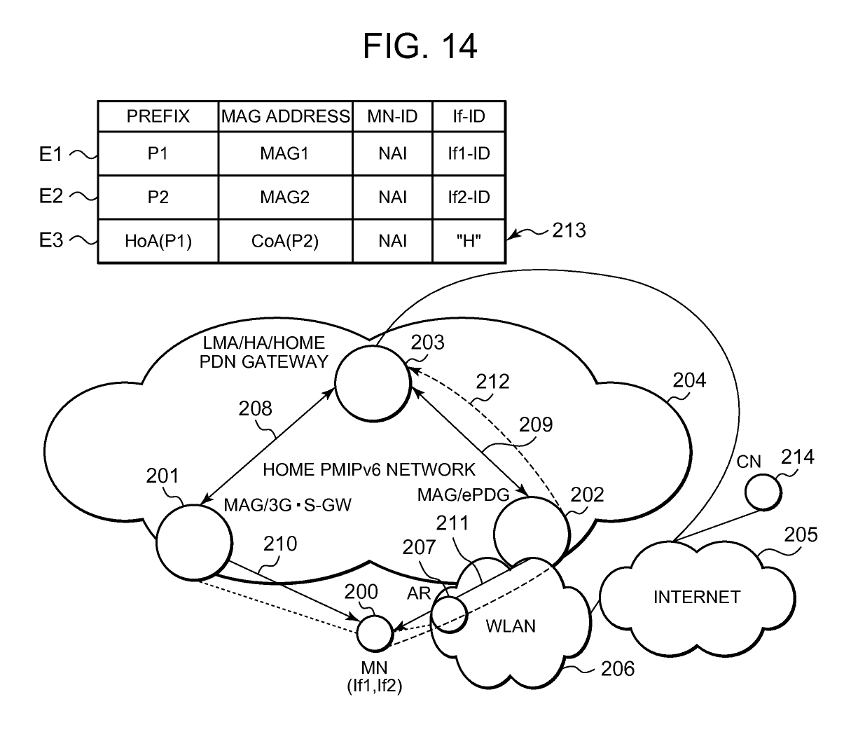

Herein it is important to understand that the CMIPv6 binding for the WLAN interface If2 is to let the MN 10 notify the LMA/HA 40 of reachability of the WLAN interface If2 using a CoA created from the foreign prefix P2. However, the actual reachablity of this CoA created from the foreign prefix P2 can be acquired from PMIPv6 binding (see FIG. 14) notified from the MAG 20 or 21. Thus, it can be concluded that the contents of the CMIPv6 binding for the WLAN interface 112 is static and relates to PMIPv6 binding for the WLAN interface If2. This is because the CoA created from the foreign prefix P2 can acquire reachability using information given from the PMIPv6 binding of the foreign prefix P2.

Thus, conventional signaling (CMIPv6 registration 50, 51 of FIG. 1) letting the MN 10 bind the CoA created from the foreign prefix P2 with the HoA created from the home prefix P1 increases signaling load relating to the MN 10. Therefore, this signaling (50, 51) can be optimized by allowing the LMA/HA 40 to create and recreate CMIPv6 binding based on the PMIPv6 binding of the foreign prefix P2. Herein, when the CoA is configured with another prefix other than a PMIPv6 local prefix, the CoA is completely independent and is an independently routable address. However, since the CMIPv6 binding of the foreign prefix P2 is not an independently routable address, the CMIPv6 binding of the foreign prefix P2 obviously needs PMIPv6 binding to secure reachability.

Thus, the PMIPv6 binding and the CMIPv6 binding of the WLAN interface If2 can be optimized, and signaling load relating to the MN 10 can be reduced, thus leading to an effect of reducing power consumption. Further, HoA information in the CMIPv6 binding is unnecessary. This is because the PMIPv6 binding of the home prefix P1 exists in a cache 213 (the first entry E1 of FIG. 14) of the LMA/HA 40, from which the HoA information can be acquired. Even when the home prefix P1 does not exist in the cache 213 of the LMA/HA 40, the LMA/HA 40 can acquire the prefix P1 by making an inquiry to an AAA server (not illustrated). Thus, the contents the MN 10 has to notify in this system are only to want to use the interface If2 referring to the foreign prefix P2 in the home MIPv6 network 100. The contents of the PMIPv6 binding existing in the LMA/HA 40 enables precise creation of the contents of the CMIPv6 binding.

### <Another Assumed System>

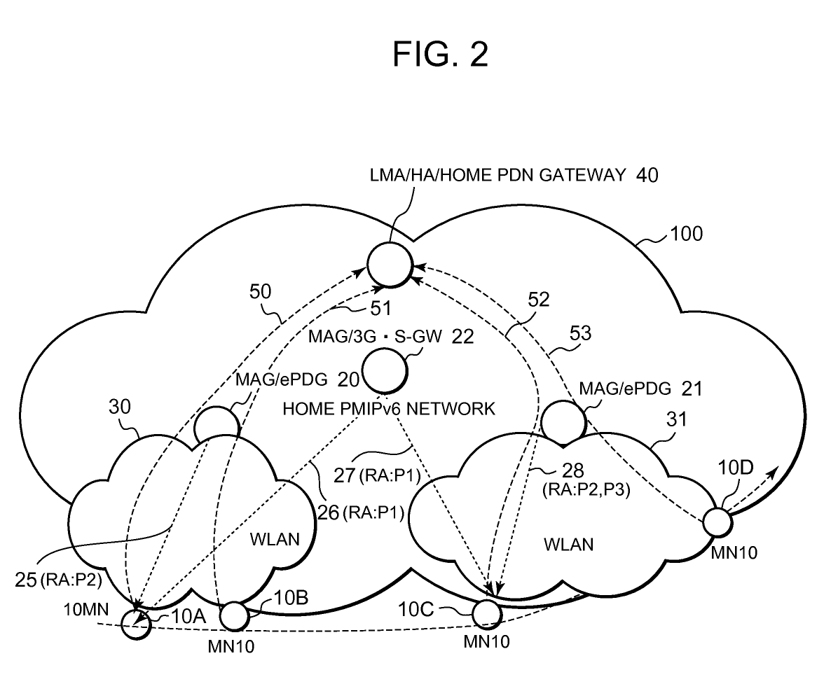

FIG. 2 illustrates another system assumed in Embodiment 1 where WLANs 30 and 31 are not disposed contiguously. This means that the respective cells of the WLANs 30 and 31 are not mutually adjacent and when the MN 10 moves to this network 100, switching of the WLAN interface If2 is performed between an active mode and an idle mode. Other points of the assumption are the same as in FIG. 1, and therefore detailed descriptions thereof are omitted. Herein, MNs 10A, 10B, 10C and 10D denote one MN 10, indicating the movement of the MN 10 in the order of 10A→10B→10C→10D. Assume that at the following first to fourth positions, the 3G cellular interface If1 of the MN 10 is stable, and a handoff of the 3G cellular interface If1 does not occur:
MN 10A: when entering the WLAN 30 (the first position);
   MN 10B: when exiting from the WLAN 30 (the second position);
   MN 10C: when entering the WLAN 31 (the third position); and
   MN 10D: when exiting from the WLAN 31 (the fourth position).

In FIG. 2, when the MN 10 is attached to a MAG 22 and a MAG 20 via a 3G cellular interface If1 and a WLAN interface If2, respectively, at the first position (MN 10A), the MN 10 refers to prefixes P1 and P2 in RA messages 26 and 25 from the MAG 22 and the MAG 20, respectively. Referring to the foreign prefix P2, the MN 10 conventionally executes CMIPv6 registration 50 to a LMA/HA 40. When the MN 10 moves to the second position (MN 10B) without connectivity with the WLAN 30, the MN 10 conventionally may transmit CMIPv6 registration deletion 51. Next, when the MN 10 moves to the third position (MN 10C of the drawing) with connectivity with another WLAN 31, the MN 10 conventionally may transmit CMIPv6 registration 52 to acquire reachability to the WLAN interface If2. Next, when the MN moves to the fourth position (MN 10D of the drawing) without connectivity with the WLAN 31, the MN 10 conventionally may transmit CMIPv6 registration deletion 53.

All BU messages for the conventional CMIPv6 registration 50 to 52 and CMIPv6 registration deletion 53 relate to BU (PBU: Proxy Binding Update) registration and PBU registration deletion for PMIPv6 connection of the WLAN interface If2. Therefore, the method described in Embodiment 1 of the present invention can reduce such signaling (50 to 53) of CMIPv6 for optimization. This is implemented by using a method enabling the LMA/HA 40 to create the contents of a CMIPv6 cache of the WLAN interface If2 when the WLAN interface If2 is attached to the network 100 as a home PMIPv6 domain. From the above description, Embodiment 1 of the present invention provides a mechanism in which the MN 10 roams in the home PMIPv6 domain 100 and determines, predicts or estimates that all interfaces If1 and If2 are attached to the home PMIPv6 domain 100, thus optimizing CMIPv6 signaling of the interface If2 referring to the foreign prefix P2.

Then, in Embodiment 1, when the MN 10 predicts that all interfaces If1 and If2 may connect with the home PMIPv6 domain 100, the MN 10 requests the LMA/HA 40 to create a CMIPv6 binding cache of the interface If2 referring to the foreign prefix P2 and maintain/manage the same without being refreshed the MN 10, so that all interfaces If1 and If2 can be used at the same time for one flow reaching one HoA of the MN 10 from the CNs 60 and 61. Herein, when assigned prefixes are different, the MN 10 may determine whether the respective interfaces connect with the same home domain or not, and then make the above-stated request to the LMA/HA 40. In this case, as described below, when the MN 10 connects with a network, the MN 10 may acquire and compare identifiers such as a domain ID and a domain number indicating a connecting domain, an operator (PLMN: Public Land Mobile Network) ID, an operator number and the like, thereby determining whether the interfaces connect with the same domain or not. Alternatively, comparison may be made between information on a prefix assigned beforehand and a prefix assigned at the time of connection with the network, whereby determination is made as to connection or not to a home domain.

### <Message Sequence and BC>

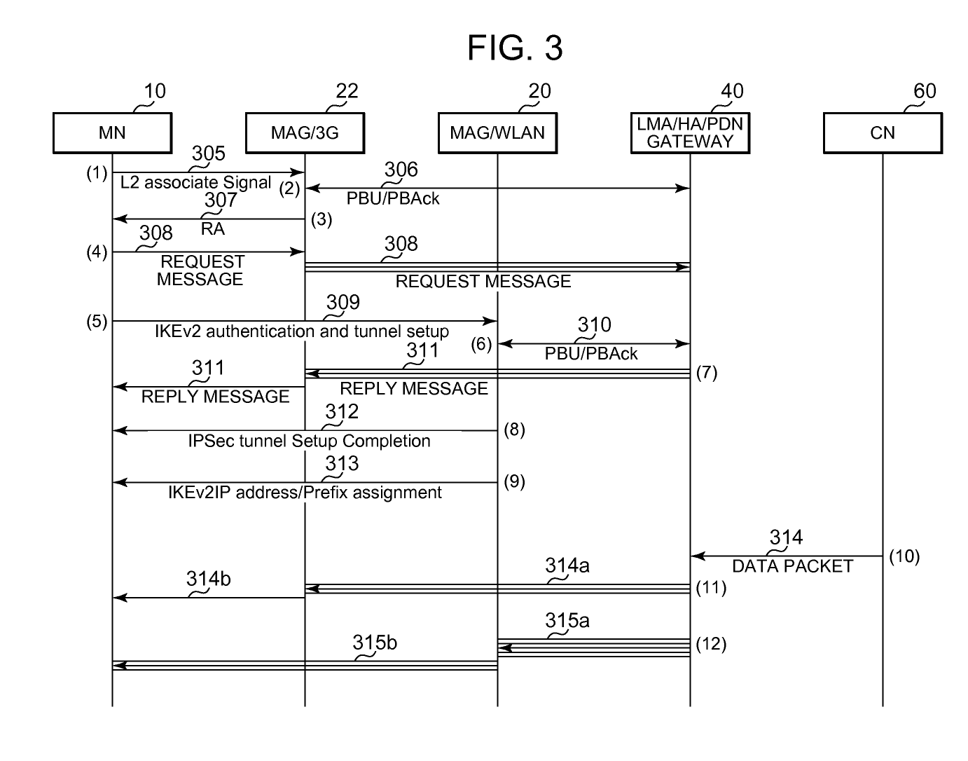

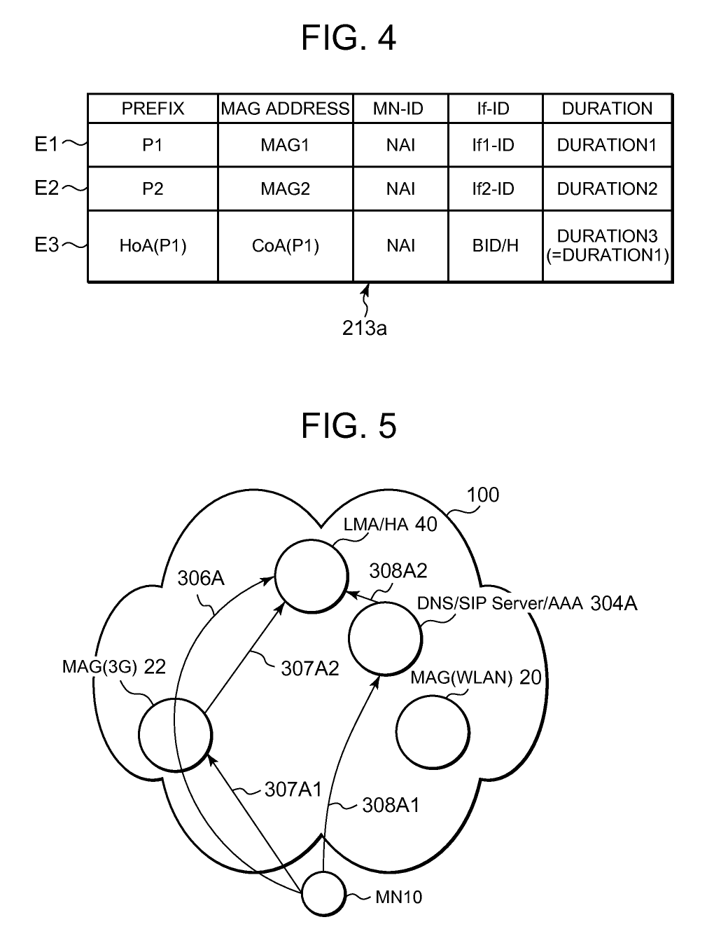

FIG. 3 illustrates a message sequence (1) to (11) according to Embodiment 1, and FIG. 4 illustrates a binding cache (BC) 213a in the LMA/HA 40. The MN 10 includes two interfaces of a 3G cellular interface If1 and a WLAN interface If2. Firstly, the MN 10 connects with a home MIPv6 domain (network 100) with one LMA/HA 40 via the 3G cellular interface Ill. The LMA/HA 40 is called a home PDN gateway as well. The MN 10 is communicating with a CN 60 connecting with another data packet network. The MN 10 has one home prefix P1 and one HoA for both of the interfaces 111 and 112, and the CN 60 transmits a data packet to the HoA of the MN 10. The MN 10 wants to receive the data packet using both of the interfaces If1 and If2.

(1) Detecting an advertisement beacon (not illustrated) from a MAG (MAG/3G) 22 via the 3G cellular interface If1, the MN 10 transmits a L2 associate signal 305 to the MAG 22. This beacon includes a certain parameter, e.g., a domain ID and a domain number characterizing a network type (whether PMIP is used or not). The MN 10 may store any static information on the domain ID of its own home MIPv6 network 100 in a memory. Thus, the MN 10 compares the domain ID acquired from the beacon with the above own static information, so as to estimate that this domain is the home MIPv6 domain 100 of the MN 10 and the MAG 22 is not the LMA/HA (LMA/HA/PDN 40 Gateway) 40 as home.

(2) Assume herein that the MN 10 transmits L2 security credential uniquely identifying the MN 10 with the L2 associate signal 305. The MAG 22 transfers this credential to a not-illustrated AAA server, and receives authorization from the AAA server. When the MN 10 is authorized, the MAG 22 transmits a PBU message to the LMA/HA 40 as indicated by PBU/PBA signaling 306, and receives a PBAck (PBA) message from the LMA/HA 40 as a reply thereof. At this time, the LMA/HA 40 creates a PMIPv6 cache of the interface If1 in the first entry E1 of the BC 213 illustrated in FIG. 4.

(3) Next, the MAG 22 transmits a RA message 307, and the MN 10 refers to the home MIPv6 prefix P1 of the MN 10 in the RA message 307.

(4) CMIPv6 cache creation•maintenance/management request message

When the MN 10 refers to the home MIPv6 prefix P1 and finds that this domain is a home MIPv6 domain, the MN 10 predicts a high probability that another interface (WLAN interface If2) of the MN 10 further connects with this same home MIPv6 domain and the LMA/HA 40. Predicting that if2 connects to the same home domain, the MN 10 transmits a CMIPv6 cache creation•maintenance/management request message 308 according to the present invention to the LMA/HA 40 via the MAG 22 (and the interface If1).

A sender address of the CMIPv6 cache creation•maintenance/management request message 308 is a HoA of the MN 10 configured from the home MIPv6 prefix P1. An object of the CMIPv6 cache creation•maintenance/management request message 308 is to request the LMA/HA 40 to create CMIPv6 binding caches (see the third entry E3 of FIG. 4) of all interfaces of the MN 10 being attached to the LMA/HA 40 and referring to the foreign prefix P2 and maintain/manage the same. The CMIPv6 cache creation•maintenance/management request message 308 contains many contents, including an identifier (If2-ID) of all interfaces (If2) of the MN 10 other than the 3G cellular interface If1 referring to the home MIPv6 prefix P1. This interface identifier (If2-ID) is used by the LMA/HA 40 to create a CoA of the interface If2 of the MN 10 referring to the foreign prefix P2 in the home MIPv6 domain. Herein, the MN 10 may make a notification of CoAs itself relating to all interfaces.

Further, as to whether the interface If2 of the MN 10 in the CMIPv6 cache creation•maintenance/management request message 308 is attached to the home MIPv6 domain or not, the LMA/HA 40 traces this using information on the PMIPv6 attachment of the MN 10 indicated by an interface identifier (If2-ID) in the CMIPv6 cache creation•maintenance/management request message 308 and an interface identifier (If2-ID) in a PBU message (signaling 310) from another MAG 20. The above-stated CoA is created by coupling the PMIPv6 prefix P2 and the interface identifier If2-ID relating to the interface If2.

The CMIPv6 cache creation•maintenance/management request message 308 further includes binding identifiers (BID) relating to all interfaces (interface identifiers). Herein, when the MN 10 includes only two interfaces If1 and If2, only information on flag H may be used. However, when two or more interfaces of the MN 10 connect with the same home MIPv6 domain and the individual CMIPv6 cache and PMIPv6 cache are to be distinguished, a BID is required for each cache.

The CMIPv6 cache creation•maintenance/management request message 308 preferably is configured with a new mobility message with a new mobility extension header. This type of mobility message requires assignment of a message identification number based on IANA (Internet Assigned Numbers Authority). The interface identifier and the BID are transmitted as options of the new mobility message. Alternatively, the mobility message may be a BU message including an interface identifier and a BID as new options. Alternatively, the CMIPv6 cache creation•maintenance/management request message 308 may be a message transmitted during an attach procedure when connecting with a 3G network, or may be a L2 message with security token addressed to the MAG 22. However, the LMA/HA 40 has to be able to decode this security token uniquely. The MAG 22 may transfer the contents of the cache creation•maintenance/management request received with the L2 message to the LMA/HA 40 with a PBU message (306). The LMA/HA 40 may use the security token to verify the effectiveness of the transferred message and process the message.

There are many methods to transmit the CMIPv6 cache creation•maintenance/management request message 308 to the LMA/HA 40. When a cache can be identified with an interface identifier, there is no need to transmit a BID. When a cache can be identified with a BID, there is no need to transmit an interface identifier. However, when the MN 10 creates a plurality of addresses from one prefix for one interface, it is appropriate to transmit a BID.

The CMIPv6 cache creation•maintenance/management request message 308 is transferred from the interface If1 to the MAG 22, and is tunneled to the LMA/HA 40. Receiving the CMIPv6 cache creation•maintenance/management request message 308, the LMA/HA 40 stores information in the CMIPv6 cache creation•maintenance/management request message 308 and monitors another interface attachment of the MN 10 via another MAG 20 in the network 100. The CMIPv6 cache creation•maintenance/management request message 308 may be transmitted via the interface If2. That is, when it can be determined that the WLAN interface If2 of the MN 10 is attached to the home PMIPv6 domain 100, the CMIPv6 cache creation•maintenance/management request message 308 may be transmitted from the If2. In this case, using a message in an attach procedure performed when the If2 connects with the MAG 20, request is made for connection with the MAG 20 and at the same time request is made for creation•maintenance/management of the CMIPv6 cache. In this case, when a network connecting with the If2 is an Untrusted network as a Non 3GPP network, request is made for creation•maintenance/management of the CMIPv6 cache during a Security Association (SA) establishment procedure (IKEv2) performed with the MAG 20 equipped with an ePDG function. On the other hand, when a network connecting with the If2 is a Trusted network as a Non 3GPP network, request is made for creation•maintenance/management of the CMIPv6 cache during access authentication performed for an Access Gateway (AGW) or during a L3 attach procedure. Thereby, there is no need for the MN 10 to transmit a BU message to create and update the CMIPv6 cache. As information requesting creation•maintenance/management of the CMIPv6 cache, when connection is performed with a 3GPP/Non 3GPP network to designate a mobility protocol used (any one of PMIPv6, CMIPv6, and MIPv4), a value (e.g., indicator (PMIPv6+CMIPv6) indicating PMIPv6 connection and simultaneous use of a plurality of IFs) meaning creation of the CMIPv6 cache at the same time may be designated instead of simply designating PMIPv6.

Further, after the WLAN interface If2 of the MN 10 completes connection with the MAG 20 and the LMA/HA 40, a CMIPv6 cache creation•maintenance/management request may be separately transmitted from the If2 with a BU message or the like. Thereby, a BU message may be transmitted only once firstly, and thereafter there is not need to transmit a BU message to update the CMIPv6 cache. Further, a CMIPv6 cache creation•maintenance/management request may be made during a SA establishment procedure (IKEv2) performed with the LMA/HA 40 prior to transmission of the above BU message. Herein, as an IKEv2 message used, an IKE_AUTH request message, an IKE_SA_INIT message and the like are preferable.

In this way, in the case where another interface If2 of the MN 10 is attached to the network 100 and a CMIPv6 cache creation•maintenance/management request is notified via the If2, the LMA/HA 40 receiving the CMIPv6 cache creation•maintenance/management request message 308 creates a CMIPv6 cache of the If2 based on PMIPv6 binding relating to the existing interface If2, and further maintains and manages the same without being refreshed by the MN 10. The CMIPv6 cache created by the LMA/HA 40 includes a HoA acquired from the CMIPv6 cache creation•maintenance/management request message 308, a CoA created from the PMIPv6 prefix P2 and an interface identifier transmitted from the MN 10. Herein, an interface identifier is 64-bit.

The LMA/HA 40 further associates this CMIPv6 binding with a BID given by the MN 10 with the CMIPv6 cache creation•maintenance/management request message 308. The LMA/HA 40 still further assigns duration to this CMIPv6 binding. This duration is the same as the duration of a first PMIPv6 binding. Herein, a second PMIPv6 binding relates to a foreign PMIPv6 prefix P2 used to create the CoA of the interface If2. Basically, the configuration of this CMIPv6 binding cache includes as indicated with the third entry E3 of FIG. 4:
HoA (home prefix P1);
CoA (foreign prefix P2+interface identifier If2-ID);
BID; and
duration 3 (=duration 1 of the first PMIPv6 binding).

(5) Next, although not illustrated in FIG. 3, after transmission of the message 308, the MN 10 receives a WLAN beacon via the WLAN interface If2. The MN 10 configures an address of the WLAN interface If2 from the prefix P2 advertised from a not illustrated access router (AR) of the WLAN 30, and thereafter finds a MAG (MAG/WLAN) 20 as an ePDG and starts an IPSec tunnel setup procedure with the MAG 20. During this procedure, the MN 10 firstly transmits an IKEv2 message (IKEV2 authentication and setup) 309 with connection authentication parameter to the MAG 20. The IKEv2 message 309 may contain information indicating connection with a Non 3GPP network connecting via the MAG 20 using PMIP. As described above, instead of the message 308, a CMIPv6 cache creation•maintenance/management request may be notified using the IKEv2 message 309 of (5). In this case, the MN 10 is notified as to whether the CMIPv6 cache creation•maintenance/management request is accepted or not with an IKEv2 completion message of (9).

(6) When an inquiry to a not-illustrated AAA server leads to authorization of the MN 10, the MAG 20 executes PBU/PBAck signaling 310 with LMA/HA 40 and creates PMIPv6 routing state of the interface If2 and the foreign prefix P2.

(7) When the LMA/HA 40 creates a PMIPv6 binding cache as the second entry E2 and thereafter finds that the MN 10 uniquely identified with the NAI includes the interface If2 connected with the LMA/HA 40, the LMA/HA 40 creates a CMIPv6 binding cache (the third entry E3) of the interface If2 relating to the PMIPv6 binding cache as the second entry E2 in accordance with a request for the above-described CMIPv6 cache creation•maintenance/management. Parameters of this cache have been already described in detail.

At this time, the LMA/HA 40 may transmit a reply message 311 in response to the solicitation message 308 to the MN 10, and may notify that the interface If2 connects with the same home MIPv6 domain 100 (LMA/HA 40), the CMIPv6 cache for the interface IF2 is automatically created by the LMA/HA 40, and further there is no need to transmit a CMIPv6-BU message (212 of FIG. 14) with BID or flag H for the interface If2. The reply message 311 is one of the methods to notify a reply from the LMA/HA 40 in response to the first message 308, which can use a CMIPv6 registration deletion message (BA message) including a type indicating a reply to the message 308. As another response method, the LMA/HA 40 may transmit a new option in a tunnel setup completion message 312 to the MAG 20 so as to notify the MN 10 not to transmit the CMIPv6-BU message 212. Alternatively, the LMA/HA 40 may make a notification to the MAG 20 or the MAG 22, and the MAG 20 or 22 may make such a notification to the MN 10 with a RA message, any other L3 message (including mobility header message) or a L2 message, for example. A lot of other methods may be available therefor.

(8) Next, a tunnel setup completion message (IPSec tunnel Setup Completion) 312 is transmitted from the MAG 20 to the MN 10.

(9) Next, the IKEv2 procedure is completed, and an IKEv2 completion message (IKEv2 IP address/Prefix assignment) 313 is transmitted from the MAG 20 to the MN 10, so that the MN 10 is notified of the foreign prefix P2. Receiving the IKEv2 completion message 313, the MN 10 does not need to transmit a CMIPv6-BU message 212 to acquire a packet addressed to the WLAN interface If2, but the LMA/HA 40 creates CMIPv6 binding for the WLAN interface If2 so that the packet reaches the WLAN interface If2.

(10) The CN 60 transmits a data packet 314 addressed to the MN 10 to the HoA of the MN 10 configured from the prefix P1. When the above packet transmitted from the CN 60 reaches the LMA/HA 40, the LMA/HA 40 executes prefix-based routing using the first entry E1 (PMIPv6 entry) in the BC 213a, and executes HoA matching routing using the CMIPv6 cache of the third entry in the BCE 213a.

(11) (12) FIG. 3 illustrates data packets 314a and 314b routed to the MN 10 using the first entry E1 (PMIPv6 cache) and data packets 315a and 315b routed to the MN 10 using the third entry E3 (CMIPv6 cache). The data packets 314a and 314b routed using the first entry E1 are tunneled via the MAG 22. If the LMA/HA 40 decides to route to the MN 10 using the CMIPv6 cache as the third entry E3, the data packet 314 undergoes a plurality of times (in this case, twice) of encapsulation by the LMA/HA 40 for tunneling (packet 315a of the drawing). In the case of the data packet 315a, the first encapsulation is tunneled to the CoA of the WLAN interface If2 of the MN 10. Then, further one more encapsulation is required, and in the second encapsulation, the data packet 315 is tunneled to the address of the MAG 20. The packet 315a subjected to twice encapsulation by the LMA/HA 40 is decapsulated by the MAG 20, and the packet 315b subjected to the original once encapsulation is transferred to the MN 10, and undergoes complete decapsulation by the MN 10. Herein, it is obvious for those skilled in the art how the LMA/HA 40 appropriately encapsulates the data packet 314 using the BC 213a illustrated in FIG. 4.

A packet addressed to the WLAN interface If2 can be directly tunneled to the MN 10. In this case, a destination address (destination address of a tunneled packet) is the address of the MAG 20, and a CoA configured from the foreign prefix P2 and a HoA of the MN 10 are inserted to a routing header type 0 of the tunneled packet. This tunneling method can prevent an increase in overhead due to unnecessary tunneling in the MAG 20.

### <Duration of CMIPv6 Cache>

As illustrated in FIG. 4, the third entry E3 (duration 3 of the CMIPv6 cache) is maintained using the first entry E1 and is deleted when the duration 1 expires irrespective of the duration 2 of the second entry E2. When the WLAN interface If2 of the MN 10 connects with a small and not contiguous cell of the WLANs 30 and 31, the WLAN interface If2 performs a handoff and is not under the control the WLANs 30 and 31 in many cases. In this case, it is effective to maintain the CMIPv6 cache of the WLAN interface If2 based on the duration 1 of the PMIPv6 cache of the 3G cellular interface If1. This is because there is no need for the LMA/HA 40 to create the CMIPv6 cache of the WLAN interface If2 frequently. Herein, it is important that the 3G cell (home PMIPv6 domain 100) is relatively larger than the WLANs 30 and 31 and the 3G cellular interface If1 does not perform a handoff often.

The following describes an operation. Firstly, when the CMIPv6 cache (duration 3) of the WLAN interface If2 of the MN 10 is maintained based on the duration 1 of the PMIPv6 cache of the 3G cellular interface If1 and the PMIPv6 cache (the second entry E2) of the WLAN interface If2 is valid before handoff, a packet reaches the WLAN interface If2 via a MAG 302 using the second entry E2. On the other hand, when the PMIPv6 cache of the WLAN interface If2 becomes not valid due to handoff, a packet addressed to a CoA relating to the WLAN interface If2 is transmitted to the 3G cellular interface If1 using the first entry E1. In this case, a MAG 301 is given some information on effectiveness of the foreign prefix P2 by the LMA/HA 40 in the tunneling packet header.

### Advantages of Embodiment 1

The following considers advantages of Embodiment 1. As a first advantage, since the LMA/HA 40 creates a CMIPv6 binding cache in response to the CMIPv6 cache creation•maintenance/management request message 308 and maintains/manages the same without being refreshed by the MN 10, there is no need for the MN 10 to transmit a CMIPv6 registration message. Further, the LMA/HA 40 can understand that there is a need to search a PMIPv6 binding cache to route a data packet using a CMIPv6 binding. When the LMA/HA 40 receives the CMIPv6 cache creation•maintenance/management request message 308 to create the CMIPv6 binding cache, the LMA/HA 40 can insert another parameter to the BC 213a indicating how a packet is routed. Thereby, as compared with the case where the LMA/HA 40 does not receive the CMIPv6 cache creation•maintenance/management request message 308 and needs to identify how a packet is routed using the CMIPv6 binding cache, load of the processing by the LMA/HA 40 can be reduced.

For instance, if the MN 10 is attached to another foreign domain via the WLAN interface If2, the LMA/HA 40 does not create a CMIPv6 binding cache as a reply to the CMIPv6 cache creation•maintenance/management request message 308, and does not mark the CMIPv6 binding cache of the WLAN interface If2 as an entry to which regressive tracing has to be conducted. Thus, the LMA/HA 40 understands that transmission to a default router is enough for routing to the CoA acquired from the foreign domain.

As another outstanding advantage, as for an interface connecting with a home MIPv6 domain to which routing is performed by the LMA/HA 40 and that can acquire a packet tunneled to an interface referring to the foreign prefix P2, there is no need for the MN 10 to execute BU. The present invention is effective to the case where the MN 10 requests to execute flag H-based BU so as to make all flows reach the WLAN interface If2 only. The MN 10 including an extremely confidential flow may want the flow to be tunneled directly to the MN 10 from the LMA/HA 40.

### <Another Format of CMIPv6 Cache Creation•Maintenance/Management Request Message 308>

FIG. 5 illustrates CMIPv6 cache creation•maintenance/management request messages 306A, (307A1, 307A2), (308A1, 308A2) in three different formats. When the MN 10 firstly is attached to the home MIPv6 domain 100 via the 3G cellular interface If1 and refers to the home prefix P1, various types of signaling can be executed so as to allow the MN 10 to request the LMA/HA 40 to create and maintain/manage a CMIPv6 binding cache of the WLAN interface If2 referring to the foreign prefix P2 from the LMA/HA 40 as described above.

(1) In a first preferable method, the MN 10 directly transmits a CMIPv6 cache creation•maintenance/management request message 306A to the LMA/HA 40. In this case, a sender address of the message 306A is a HoA of the MN 10 configured using the home prefix P1, and a destination address thereof is an address of the LMA/HA 40. The message 306A can be configured using a new header type of an extension header. Such a new header type of the extension header used in the message 306A slightly simplifies the processing of the message 306A at the LMA/HA 40. The LMA/HA 40 understands the new header type based on the message 306A and understands how the message 306A is processed.

Information to identify another interface (WLAN interface If2) of the MN 10 such as an interface identifier and a BID can be embedded as an option in the message 306A or in a data field. The message 306A is tunneled from the MAG 22 to the LMA/HA 40. In the case where the message 306A is a BU message described in MIPv6, the above-stated interface identifier and BID of the other interface are embedded as a mobility option in a BU message. This mobility option is an option of a new type.

(2) Instead, a CMIPv6 cache creation•maintenance/management request may be transmitted with a L2 message 307A1 that is transmitted to the MAG 22. This L2 message 307A1 transmits the interface identifier and the BID of the other interface as stated above. Herein, the sender address of the L2 message 307A1 is a L2 address of the interface If1 of the MN 10, and a destination address thereof is a L2 address of an ingress interface of the MAG 22. Receiving the above-stated parameters (interface identifier and BID) with the message 307A1, the MAG 22 transmits the contents of the message 307A1 with a message 307A2 addressed to the LMA/HA 40. Any other L3 message (including mobility header message) such as a RS message, a NS message or an authentication message (IKEv2 message) that includes the same contents as those of the above L2 message may be used. Further, notification may be conducted during an attach procedure (attach request message) performed for connection with the 3GPP network (MAG 22).

The message 307A2 may be a PBU message, or may be another signaling message with a new mobility extension header. Herein, when the message 307A2 is a PBU message, the above-stated interface identifier and BID of the other interface has to be inserted into the PBU message as a new mobility option so as to allow the LMA/HA 40 to understand how the PBU message is processed and to understand the CMIPv6 cache creation•maintenance/management request. When the message 307A2 is another signaling message with a new mobility extension header, the above-stated interface identifier and BID of the other interface may be inserted into a normal field in the message. In this case, however, the configuration of the LMA/HA 40 has to be modified for understanding of this new message. Receiving this new message, the LMA/HA 40 with the thus modified configuration understands how the message is processed.

(3) In the case where the MN 10 selects the home prefix P1 via the 3G cellular interface If1, the MN 10 may first notify a DNS server 304A (DNS/SIP server/AAA in the drawing) of such selection as indicated with a message 308A1, and provide the above-stated interface identifier and BID of the other interface with the message 308A1. The DNS server 304A accepts this new prefix P1 and transfers the selected prefix P1 and the contents of the CMIPv6 cache creation•maintenance/management request message 308 to the LMA/HA 40 with a message 308A2.

Herein, it should be understood that each method with the CMIPv6 cache creation•maintenance/management request message 306A, (307A1, 307A2), (308A1, 308A2) has a specific advantage. In the case of the message (308A1, 308A2), the following two can be implemented. Firstly, when the home prefix P1 is selected, a request is made to the LMA/HA 40 for CMIPv6 cache creation•maintenance/management. Secondly, when the MN 10 transmits a message 308A1 so as to identify a WLAN access point, the MN 10 can acquire an ePDG address.

### <Format of CMIPv6 Cache Creation•Maintenance/Management Request Message 308>

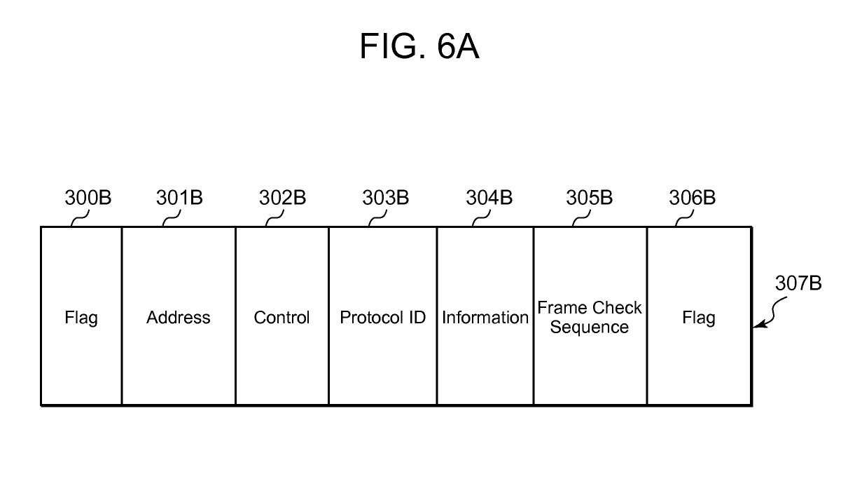

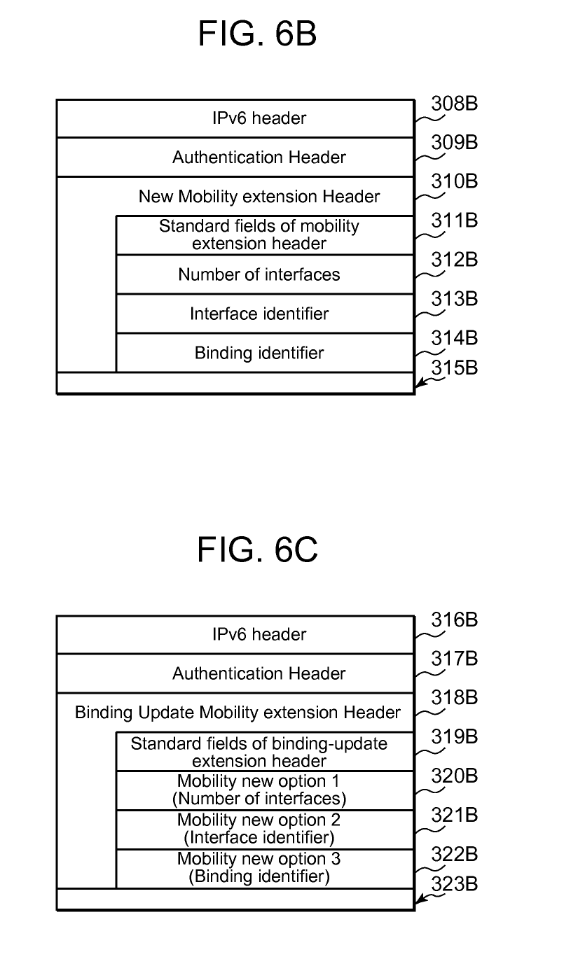

The following describes three configuration examples of the message 308, with reference to FIG. 6A, FIG. 6B and FIG. 6C.

(a) A frame 307B illustrated in FIG. 6A illustrates a frame configuration in the case where the message 308 is a L2 message 307A, configured with fields of a start flag (Flag) 300B, an address 301B, control 302B, a protocol ID 303B, information 304B, FCS (Frame Check Sequence) 305B and an end flag (Flag) 3066 from the head thereof.

The start flag 300B indicates the head of the frame 307B, and the address 301B in the second field is a MAC (Media Access Control) address, including a sender address and a destination address of a L2 packet. For instance, the sender address is a MAC address of the interface If1 of the MN 10, and the destination address is a MAC address of an ingress interface (not illustrated) of the MAG 22. The control 3026 in the third field is information to identify a frame type used, which is important to enable a reception side to correctly process this frame 307B of L2. Basically, the control 302B is used to identify a type of the frame 3076, i.e., a type of the CMIPv6 cache creation•maintenance/management request message 308 (307A).

The protocol ID 303B in the fourth field is a value only for a packet generated at an upper layer, and when the message 308 (307A) is generated at L2, this shows all zero. However, even when the message 308 can be generated at L2, decision to transmit the message 308 and related parameters embedded in the message 308 have to come from L3. The information 304B in the next field includes the interface identifier and the BID. The FCS 305B field follows the information 304B, where the FCS 3056 is calculated by the transmission side and the reception side so that the frame 307B can be transmitted without an error (an error can be identified and corrected). The end flag 306B in the last field is used as a delimiter of the frame 307B basically to identify the end of the frame 307B.

Herein, the configuration of the frame 307B does not have to be the same as the configuration illustrated in FIG. 6A within a range without departing from the present invention. As described above, the MN 10 can transmit a packet to transmit the CMIPv6 cache creation•maintenance/management request message 308 at L3. When signaling at L3 is used, the MN 10 can use a BU message with a new mobility extension header or a new option.

(b) FIG. 6B illustrates a signaling packet 315B with a new mobility extension header 310B. The packet 315B is described below in detail. A first header of the packet 315B is a standard IPv6 header 308B, including a sender address to which the HoA of the MN 10 is set and a destination address to which the address of the LMA/HA 40 is set. The next header in the packet 315B is an authentication header 309B, including authentication data with signature using a security key exchanged between the MN 10 and the LMA/HA 40. The header 309B is a preferable field, but is not essential.

A third header is a new mobility extension header 310B, including firstly standard fields of mobility extension header 311B, the standard fields of mobility extension header 311B including a protocol number, a mobility/header type, checksum and the like. The new mobility extension header 310B further includes three standard fields 312B, 313B and 314B. A first field (number of interfaces) 312B indicates the number of interface If2 that the MN 10 excludes from the interface If1 referring to the home prefix P1. The next field (interface identifier) 313B indicates the interface identifier If2-ID of the interface If2 of the first field 3128. A third field (Binding identifier) 314B indicates one or more BIDs relating to the interface identifier If2-ID of the second field 313B. It should be emphasized that there are many methods to configure fields of the new mobility extension header 310B. The packet 315B is described here as one of preferable methods.

(c) FIG. 6C illustrates a configuration of a packet 3238 of a BU message as a third example to transmit the CMIPv6 cache creation•maintenance/management request message 308. Similarly to FIG. 6B, a first header of the packet 3238 is an IPv6 header 316B, and a next header is preferably an authentication header 317B. A BU (Binding Update) mobility extension header 318B follows the authentication header 317B. A first field of the header 318B is standard fields of mobility extension header 319B, including all standard fields in BU such as duration and a sequence number.

Following the standard fields of mobility extension header 319B, new option fields (Mobility new options 1, 2, 3) 320B, 321B, 322B are provided. Similarly to FIG. 6B, a first option field (Mobility new option 1) is the number of interfaces. A second option field (Mobility new option 2) 321B is an interface identifier that the MN 10 wants to optimize, and a third option field (Mobility new option 3) includes one or a plurality of BIDs relating to a certain interface.

### <Operation by MN>

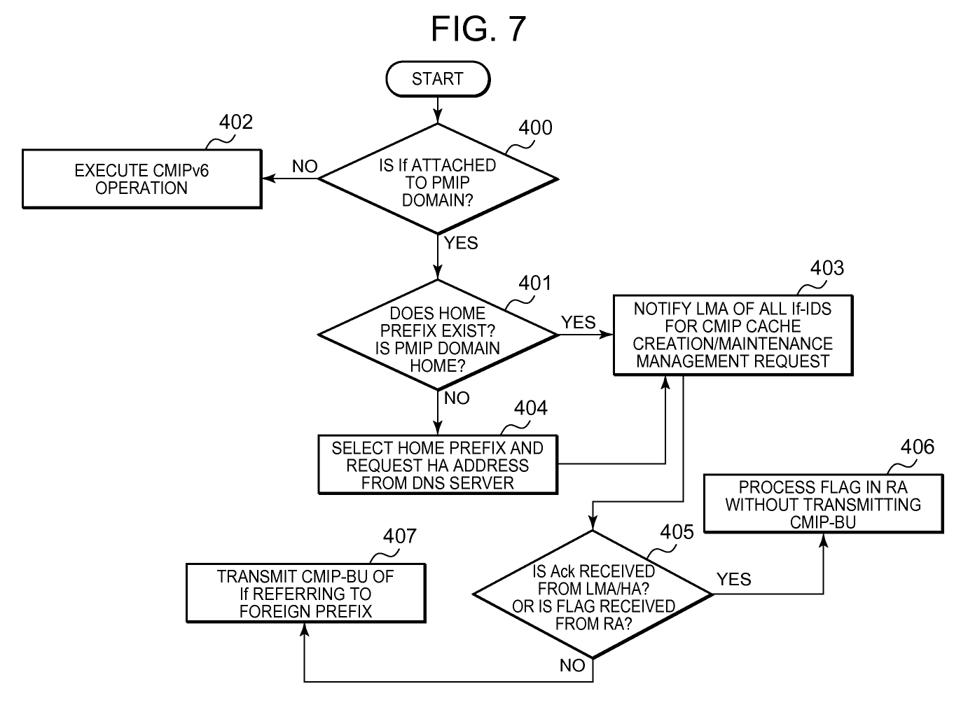

The following describes an operation by the MN 10 in further detail with reference to FIG. 7. When the MN 10 with a plurality of interfaces Ifs firstly is attached to a certain network entity via a certain interface If, the MN 10 checks whether the interface If is attached to a PMIPv6 domain or not (Step 400). In the case of NO, the MN 10 performs a normal CMIPv6 operation (Step 402). In the case of YES at Step 400, the MN 10 checks whether a prefix given to the interface If from the PMIPv6 domain is a home prefix P1 or not, and further checks whether this home prefix P1 is understood or not (Step 401). In the case of YES, the MN 10 transmits a CMIPv6 cache creation•maintenance/management request message 308 with all interface identifiers to the LMA/HA 40 (Step 403).

In the case of NO at Step 401, that is, in the case where the home prefix P1 is not included, the MN 10 selects a PMIPv6 prefix as the home prefix P1, and requests an address of HA from a DNS server to acquire the same (Step 404). Herein, assume that the DNS server updates the LMA/HA 40 as home with the home prefix P1 that the MN 10 selects. After the processing at Step 404, processing at Step 403 is executed. Since NO at Step 401 and the absence of the home prefix P1 implicitly indicate that the MN 10 is attached to a foreign PMIPv6 domain, the MN 10 performs a normal CMIPv6 operation.

After the processing at Step 403, the MN 10 checks whether Ack in response to the CMIPv6 cache creation•maintenance/management request message 308 is received or not or a reply thereof (flag) is described in a RA message or an IPsec tunnel establishment confirmation message or not (Step 405). In the case of YES, the MN 10 does not transmit a BU message of CMIPV6 but processes the flag in the RA message (Step 406). This is because a CMIPv6 cache of the interface if2 referring to a foreign prefix P2 given from the home LMA/HA 40 is created and maintained/managed by the home LMA/HA 40. In the case of NO at Step 405, this means that the interface If2 of the MN 10 does not connect with the same LMA/HA 40 using PMIPv6 binding, the MN 10 transmits a CMIPv6-BU message to acquire reachability to the interface If2 (Step 407).

### <Operation by LMA/HA>

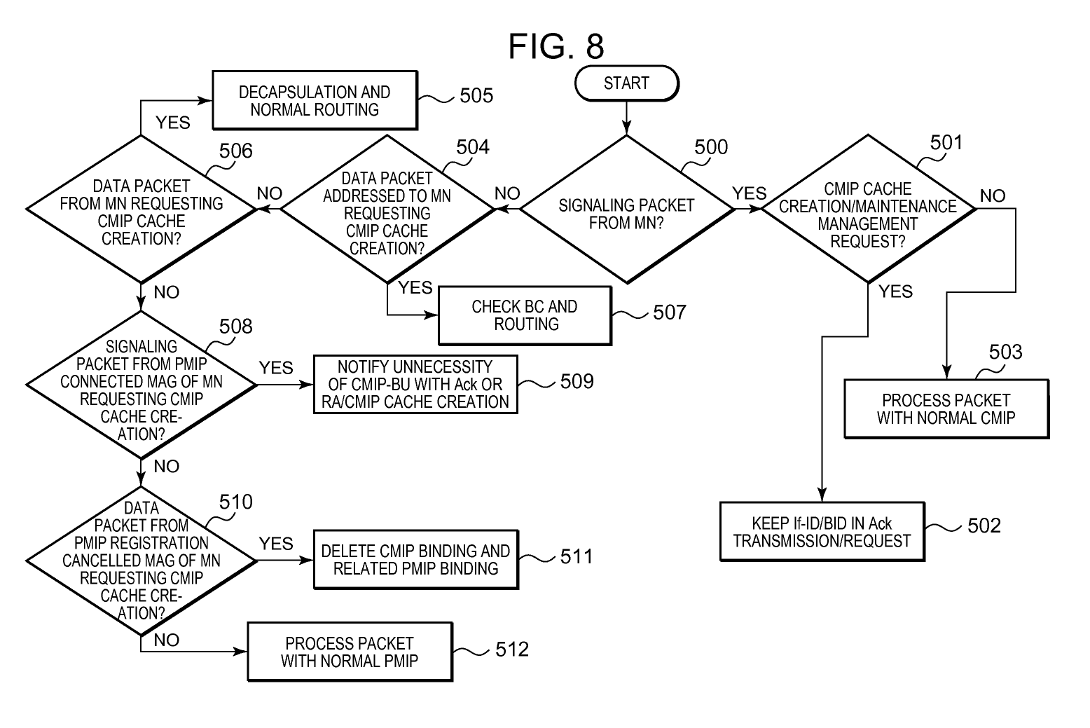

Referring now to FIG. 8, an operation by the LMA/HA is described below in further detail. Firstly receiving a packet, the LMA/HA 40 checks whether the received packet is a signaling packet from the MN 10 or not (Step 500). In the case of YES, the LMA/HA checks whether the received packet is a CMIPv6 cache creation•maintenance/management request message 308 or not (Step 501). In the case of NO, the LMA/HA processes the received packet with a standard CMIPv6 operation (Step 503). In the case of YES at Step 501, the LMA/HA transmits an Ack message in response to the CMIPv6 cache creation•maintenance/management request message 308, and temporarily keeps an interface identifier If-ID and a BID in the CMIPv6 cache creation•maintenance/management request message 308 (Step 502).

In the case where the received packet is not a signaling packet from the MN 10 at Step 500, the LMA/HA checks whether the received packet is a data packet addressed to the MN 10 transmitting the CMIPv6 cache creation•maintenance/management request message 308 or not (Step 504). In the case of YES, the LMA/HA checks a BC 231a, and routes the received packet via all interfaces Ifs of the MN 10 or via a specific interface If according to preference set by the MN 10 (Step 507). In the case of NO at Step 504, the LMA/HA checks whether the received packet is a data packet from the MN 10 transmitting the CMIPv6 cache creation•maintenance/management request message 308 or not (Step 506). In the case of YES, the LMA/HA decapsulates the received packet and routes the same via an egress interface (Step 505). During decapsulation, the LMA/HA 40 checks whether a tunnel entry point is a sender address validly registered in the BC 213a.

In the case of NO at Step 506, the LMA/HA 40 checks whether the received packet is a signaling packet from a MAG that indicates PMIPv6 attachment of the MN 10 transmitting the CMIPv6 cache creation•maintenance/management request message 308 or not (Step 508). In the case of YES, the LMA/HA 40 transmits an Ack message, thereby notifying that another interface If2 of the MN 10 is attached to the same LMA/HA 40, and that in the case where an Ack message is not transmitted before, there is no need for the MN 10 to execute CMIPv6-BU. Or the LMA/HA notifies that there is no need to execute CMIPv6-BU with a RA message (Step 509). Herein, there is no need to transmit an Ack message to the interface If2 attaching firstly and referring to the foreign prefix P2. At Step 509, the LMA/HA 40 further creates a CMIPv6 cache of the interface If2 referring to the foreign prefix P2.

In the case of NO at Step 508, the LMA/HA 40 checks whether the received packet is a signaling packet from a MAG, indicating PMIPv6 registration cancellation of the MN 10 transmitting the CMIPv6 cache creation•maintenance/management request message 308 or not (Step 510). In the case of YES, the LMA/HA 40 deletes from the BC 213a the CMIPv6 binding (the third entry E3) and the PMIPv6 binding (the second entry E2) relating to the CMIPv6 binding (Step 511). The CMIPv6 binding herein means binding created using a parameter of the PMIPv6 binding at Step 509. In the case of NO at Step 510, the LMA/HA 40 processes the received signaling packet with a normal PMIPv6 operation (Step 512).

### <Configuration of MN>

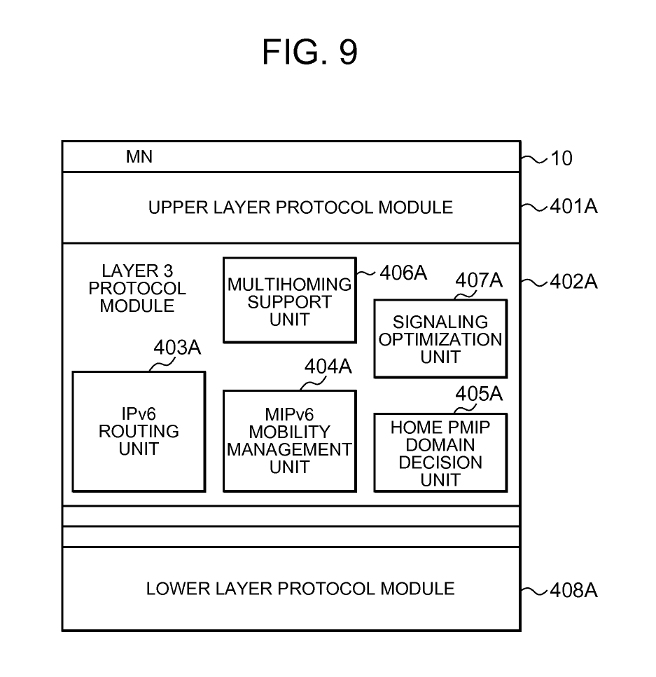

Referring now to FIG. 9, the configuration of the MN 10 is described below in detail. FIG. 9 is a functional block diagram illustrating hardware, software and firmware of the MN 10. Functions of the MN 10 schematically are made up: a layer 3 protocol module 402A; an upper layer protocol module 401A running a protocol of an upper layer upper than layer 3; and a lower layer protocol module 408A running a protocol of a lower layer lower than layer 3. The lower layer protocol module 408A is made up of a plurality of layers of protocol module relating to the respective interfaces Ifs of the MN 10, and a function of the lower layer protocol module 408A mainly relates to control and transmission mechanism of a data link layer.

The layer 3 protocol module 402A specifically is made up of five sub-modules (units), i.e., an IPv6 routing unit 403A, a MIPv6 mobility management unit 404A, a home PMIP domain decision unit 405A, a multihoming support unit 406A, and a signaling optimization unit 407A. Although not illustrated here, the layer 3 protocol module 402A includes an interface to transmit a message among the respective units 403A to 407A. Each unit 403A to 407A includes binding related thereto.

The IPv6 routing unit 403A is in charge of mechanisms for neighbor discovery, address configuration, and basic routing of IPv6. The MIPv6 mobility management unit 404A is in charge of mechanisms for MIPv6 mobility management such as execution of BU and registration cancellation. The multihoming support unit 406A is in charge of functions of MONAMI6 (Non-Patent Document 4: plural CoA registration) such as creation of a BID and attachment of flag H to a BU message. The signaling optimization unit 407A is in change of functions when the MN 10 configures the CMIPv6 cache creation•maintenance/management request message 308 according to the present invention. The home PMIP domain decision unit 405A is in charge of functions for a decision as to whether the MN 10 tries to be attached to a PMIPv6 domain or not. Herein, it is obvious for those skilled in the art that each unit 403A to 407A needs an appropriate software interface.

Finally, the upper layer protocol module 401A is in charge of a protocol of upper layers such as a transport layer and an application layer provided in the MN 10. Although the upper layer protocol module 401A is illustrated with one block, it is obvious for those skilled in the art that the upper layer protocol module 401A may be made up of a plurality of blocks within a range without departing from the present invention.

### <Configuration of LMA/HA>

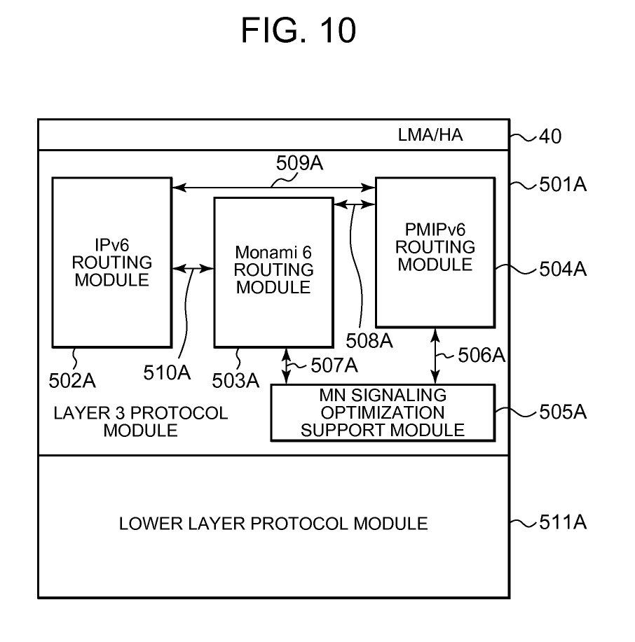

Referring now to FIG. 10, the configuration of the LMA/HA 40 is described below in detail. FIG. 10 is a functional block diagram of the LMA/HA 40. The LMA/HA 40 schematically is made up of two functional entities of: a routing layer, i.e., a layer 3 protocol module 501A; and a lower layer protocol module 511A running a protocol of a lower layer lower than layer 3. Although not illustrated, an appropriate interface exists between the modules 501A and 502A. The layer 3 protocol module 501A includes as four sub-modules an IPv6 routing module 502A, a Monami6 routing module 503A, a PMIPv6 routing module 504A, and a signaling optimization support module 505A.

The IPv6 routing module 502A is in charge of a basic mechanism in one hop, an address configuration of an ingress interface and an egress interface (not illustrated) of the LMA/HA 40, and a mechanism of normal packet routing or neighbor discovery. The Monami6 routing module 503A is a multihoming module equipped with a HA function capable of processing multihoming signaling. Herein, the module 503A especially is capable of processing a flag H and a BID, and is capable of maintaining a plurality CMIPv6 binding entries for one HoA using BIDs individually. The IPv6 routing module 502A and the Monami6 routing module 503A include a signaling interface 510A, where the signaling interface 510A is important to process signaling and a data packet of a CMIPv6 type and route the data packet.

The PMIPv6 routing module 504A is in charge of genuinely all functions of a LMA type. The functions of the LMA type include to maintain a PMIPv6 cache of the MN 10 with a plurality of interfaces, to tunnel a packet addressed to the MN 10 via a MAG, to process a received PBU message, to create a PBA message to be transmitted and the like. The module 504A further includes a signaling interface 509A with the IPv6 routing module 502A, where the signaling interface 509A is used to process signaling and a data packet using a PMIPv6 cache and route the data packet. Assume herein that the Monami6 routing module 503A and the PMIPv6 routing module 504A each include its own BCE. Assume further that the PMIPv6 routing module 504A and the Monami6 routing module 503A are very strongly coupled.

Herein, since a CMIPv6 cache is maintained separately from a PMIPv6 cache, the PMIPv6 routing module 504A and the Monami6 routing module 503A are illustrated separately. However, when a signaling message to separate the CMIPv6 cache and the PMIPv6 cache does not include a BID and flag H therein and the CMIPv6 cache can overwrite the PMIPv6 cache, the PMIPv6 routing module 504A, the Monami6 routing module 503A, the CMIPv6 cache and the PMIPv6 cache have to operate mutually. As described above, even when the CMIPv6 cache and the PMIPv6 cache are provided separately, they have to operate closely and mutually. Herein, for those skilled in the art, the CMIPv6 cache and the PMIPv6 cache may be provided separately depending on a form actually used. Instead, the PMIPv6 routing module 504A and the Monami6 routing module 503A are provided separately as illustrated in FIG. 10, whereas the CMIPv6 cache and the PMIPv6 cache may be provided together.

Finally, the signaling optimization support module 505A as an important element is described below. The signaling optimization support module 505A is provided to process the CMIPv6 cache creation•maintenance/management request message 308 and create a CMIPv6 cache in the Monami6 routing module 503A. The module 505A communicates with the module 503A via a signaling interface 507A. The signaling interface 507A is used to transfer a message such as a CMIPv6 cache creation•maintenance/management request message and a necessary parameter to create and maintain/manage a CMIpv6 cache.

The signaling optimization support module 505A further monitors whether the other interface If2 of the MN 10 is attached to the PMIPv6 domain or not. As for this monitoring, the signaling optimization support module 505A requires a signaling interface 506 with the PMIPv6 routing module 504A. When the signaling optimization support module 505A finds from the PMIPv6 routing module 504A via the signaling interface 506 that the other interface If2 of the MN 10 is attached to the PMIPv6 domain, the signaling optimization support module 505A decides to notify the MAG that the MN 10 does not transmit a CMIPv6-BU message. This notification information is configured by the signaling optimization support module 505A and is transferred to the PMIPv6 routing module 504A. That is a preferable configuration of the LMA/HA 40. However, the LMA/HA 40 can be configured within a range without departing from the present invention.

### Embodiment 2

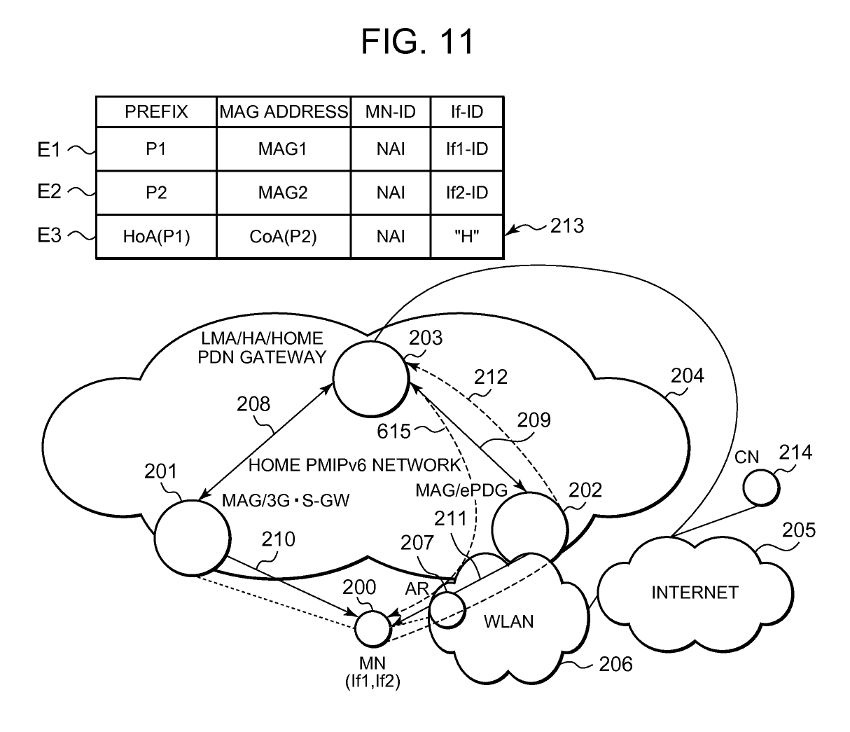

The following describes Embodiment 2 with reference to FIG. 11. A network illustrated in FIG. 11 is the same as above except that a BU message transmission stop request signal 615 of CMIPv6 is added instead of the CMIPv6 cache creation•maintenance/management request message 308. The following briefly and repeatedly describes elements and signals illustrated in FIG. 11. In the network illustrated in FIG. 11, a MN 200 with a plurality of interfaces (a 3G cellular interface If1 and a WLAN interface If2) is connected to a home PMIPv6 network (domain) 204 via both of the interfaces If1 and If2. At this time, the 3G cellular interface If1 is connected with a LMA/HA 203 via a MAG 201 of the home PMIPv6 network 204, and the WLAN interface If2 is connected with the LMA/HA 203 via an AR 207 of a WLAN 206 and a MAG 202 of the home PMIPv6 network 204. Further, the WLAN 206 is connected with the Internet 205, and the MN 200 communicates with a CN 214 connecting with the Internet 205.

In the above configuration, when the MN 200 is firstly attached to the MAG 201 via the 3G cellular interface If1, the MAG 201 transmits a PBU message (signaling 208) to the LMA/HA 203 so that a first entry E1 (PMIPv6 cache) is created in a BC 213 of the LMA/HA 203, and the MN 10 refers to a home prefix P1 of MIPv6. Similarly, when the MN 200 triggers tunnel establishment for the MAG 202, the MAG 202 transmits a PBU message (signaling 209) to the LMA/HA 203 so that a second entry E2 (PMIPv6 cache) is created in the BC 213 of the LMA/HA 203. As a result, the MN 20 refers to a foreign prefix P2 given by the LMA/HA 203 with an IPSec completion message 211.

Assume herein that the MN 200 wants a flow addressed to a HoA configured from the home prefix P1 to come via the WLAN interface If2. Further as described above, the MN 10 includes one home prefix P1 and one HoA only for the interfaces If1 and If2. When the MN 10 wants a flow addressed to one HoA to come from the CN 214 via the WLAN interface If2, the MN 10 transmits to the LMA/HA 203 a CMIPv6-BU message 212 with flag H indicating to attach home and away, thus creating a third entry E3 (CMIPv6 cache) in the BCE 213 of the LMA/HA 203. It is important herein that the CMIPv6-BU message 212 with flag H does not overwrite the PMIPv6 cache as the first entry E1. Thus, all of the three entries E1, E2 and E3 can coexist and the LMA/HA 203 can maintain different types of bindings (PMIPv6 cache and CMIPv6 cache).

The LMA/HA 203 in Embodiment 2 is equipped with a function to check the CMIPv6-BU message 212 and detect that the second entry E2 (PMIPv6 cache) is required to use the CMIPv6 registration (the third entry E3). Further the LMA/HA 203 estimates that there is no need to continue the CMIPv6-BU message 212 and the LMA/HA 203 can create and maintain/manage CMIPv6 binding using the second entry E2 (PMIPv6 cache). Once the LMA/HA 203 decides like this, the LMA/HA 203 directly notifies the MN 200 as such with a BU message transmission stop request signal 615 of CMIPv6. Receiving the signal 615, the MN 200 no longer transmits the CMIPv6-BU message 212. However, this is not the case where the MN 200 refers to a new prefix that is not the foreign prefix P2 in the domain 204 and the case where the LMA/HA 203 notifies the MN 200 of cancellation of this optimization service.

In both of the cases where cells of the WLAN 206 are contiguous like tiles or not contiguous, various modification examples can be considered to cope with a problem occurring when the MN 200 continuously transmits the CMIPv6-BU message 212 to the foreign prefix P2 coming from the LMA/HA 203 as home. However they are not a method to cope with the problem most effectively. The following considers problems. Firstly, there is some degree of complexity when the LMA/HA 203 as home makes a decision concerning this optimization service or the possibility. Secondly, the LMA/HA 203 as home wastefully searches for a CoA configured from the foreign prefix P2 that does not belong to the LMA/HA 203 as home (searches whether binding of CoA includes PMIPv6 binding or not). Since the LMA/HA 203 does not receive the CMIPv6 cache creation•maintenance/management request message 308 as in Embodiment 1, the LMA/HA 203 does not understand to which the WLAN interface If2 of the MN 200 is attached, and therefore the above CoA search will be wasted efforts.

Thirdly, the LMA/HA 203 needs a BU message from the WLAN interface If2 of the MN 200 to identify possible optimization. Herein, in Embodiment 1, the CMIPv6-BU message 212 from the WLAN interface If2 of the MN 200 is unnecessary, and the CMIPv6 cache creation•maintenance/management request message 308 suffices. However, an advantage of Embodiment 2 resides in that although there is no need for the MN 200 to predict connection with the home PMIPv6 domain 204, the MN 200 needs to transmit an interface identifier and a BID of the WLAN interface If2 to the LMA/HA 203. In Embodiment 2, all processing necessary to reduce signaling load is executed by the LMA/HA 203. When there are many LMA/HAs, a lot of processing load can be put on these LMA/HAs 203 for implementation.

### Embodiment 3

The following describes Embodiment 3 with reference to FIG. 11 described above. Assume herein that in FIG. 11 the MN 200 understands connection with the home PMIPv6 domain 204 via the WLAN interface If2. As for such information, the MN 200 refers to a beacon of the WLAN 206 and understands from the MAG 202 that the MAG 202 establishes a tunnel with the LMA/HA 203. Based on the above information, the MN 200 understands that signaling optimization can be conducted for the BU of CMIPv6, and transmits the BU message 212 of CMIPv6 to the LMA/HA 203. Herein, this BU message 212 includes BIDs of the interfaces If1 and If2 attached to the LMA/HA 203, in which a very long duration is described. A feature of Embodiment 3 resides in that when the MN 200 is attached for very long duration, there is no need for the MN 200 to refresh BU.

In this case, when the MN 200 roams in the home PMIPv6 domain 204 longer than the duration described in the BU message 212, the third entry E3 has to be refreshed. Further, when the LMA/HA 203 does not accept very long duration (cannot guarantee a mobility service for long duration), the MN 200 may understand the maximum value of duration that the LMA/HA 203 accepts, and make a notification of the same with the BU message 212. The LMA/HA 203 may accept or reject BU from the MN 200 depending on its own load state. Thus, the LMA/HA 203 may not be able to accept binding for very long duration or static or hard-code binding. In this case, the LMA/HA 203 may notify the MN 200 whether the binding for very long duration can be accepted or not, and accordingly the MN 200 may determine as to whether the BU message 212 with the long duration is to be transmitted or not.

In the case where the WLAN 206 is not contiguous as in the WLANs 30 and 31 illustrated in FIG. 2, and if a new foreign prefix P2 is given to the WLAN interface If2 at the time of turn-ON and OFF of the WLAN interface If2, it can be determined that the BU message with long duration is not transmitted to the foreign prefix P2. Thereby, a foreign prefix used for a relatively short time can be dealt with as a normal binding cache. Since the MN 200 includes a plurality of interfaces If1 and If2, the BU message 212 with long duration is transmitted to the respective interfaces If1 and If2. A major advantage of Embodiment 3 resides in that a change in configuration of the MN 200 is minimum. The MN 200 with extension MIPv6 task (functions of Monami6) can cope with a problem of signaling storm without changing software.

### Embodiment 4

Referring again to FIG. 11 as described above, the following describes Embodiment 4. In Embodiment 4, the LMA/HA 203 estimates that the signaling optimization in Embodiment 2 can be executed when receiving the BU message 212 of CMIPv6 from the MN 200, the LMA/HA 203 returns, as a reply to the BU message 212, a binding ack (BA) message (not illustrated) with very long duration described therein to the MN 200 instead of the BU message transmission stop request signal 615 of CMIPv6. The MN 200 does not transmit a new BU message 212 to the LMA/HA 203 until the duration in this BA message expires.

Note that even in Embodiment 4 the MN 200 has to refresh a CMIPv6 cache when the duration in the BA message expires. A major advantage of Embodiment 4 resides in that more processing load can be shifted to a network side and not to a MN side. Further as compared with Embodiment 2, the operation by the LMA/HA 203 can be simplified.

### Embodiment 5

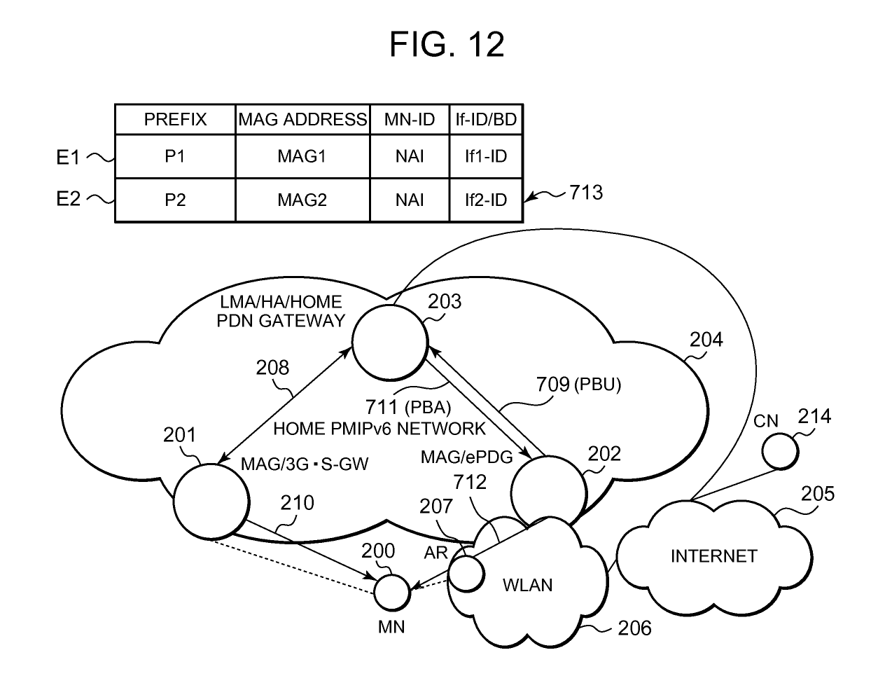

Referring next to FIG. 12, Embodiment 5 is described below. In FIG. 12, a MN 200, MAGs 201, 202, a LMA/HA 203, a home PMIPv6 domain 204, the Internet 205, a WLAN 206 and a CN 214 are the same as in FIG. 11. However, it does not include the BU message 212 of CMIPv6 illustrated in FIG. 11 and a third entry E3 in BC 713.

In the above configuration, similarly to FIG. 11, when the MN 200 firstly is attached to the MAG 201 via the 3G cellular interface If1, the MAG 201 transmits a PBU message (signaling 208) to the LMA/HA 203 so that a first entry E1 (PMIPv6 cache) is created in the BCE 713 of the LMA/HA 203, and the MN 10 refers to a home prefix P1 of MIPv6. Similarly, when the MN 200 triggers tunnel establishment to the MAG 202, the MAG 202 transmits a PBU message 709 to the LMA/HA 203 so that a second entry E2 (PMIPv6 cache) is created in the BCE 713 of the LMA/HA 203.

In Embodiment 5, when the LMA/HA 203 creates the second entry E2 (PMIPv6 cache) in the BCE 713, the LMA/HA 203 can estimate using a NAI that both of the PMIPv6 caches belong to the same MN 200. Thus, the LMA/HA 203 gives an instruction to the MAG 202 with a PBA message 711 as a reply of the PBU message 209, and the MAG 202 notifies the MN 200 with a RA/IKEv2 completion message 712 so as not to transmit the BU message 212 of CMIPv6 illustrated in FIG. 11 when the MN 200 refers to a foreign prefix P2. Further, the LMA/HA 203 gives an instruction to the MAG 202 with the PBA message 711, thus making the MAG 202 notify the MN 200 to perform load-balancing of a flow for the home prefix P1 among the plurality of interfaces If1 and If2.

The following considers an operation in Embodiment 5 in detail. The configuration of the LMA/HA 203 is changed so that the LMA/HA 203 identifies the first and the second entries E1 and E2 of the BCE 713 belonging to the same MN 200 and further identifies that a packet addressed to the home prefix P1 can be routed via the PMIPv6 cache (the second entry E2) of the foreign prefix P2. Then, the LMA/HA 203 notifies the MAG 202 of the home prefix P1 with the PBA message 711 transmitted for the foreign prefix P2, and the MAG 202 transmits a special option with the RA message 712. This special option is a flag to notify the MN 200 so as not to transmit the BU message 212 of CMIPv6 illustrated in FIG. 11 when the MN 200 refers to the foreign prefix P2. It is important herein that since the MAG 202 is notified of the home prefix P1 with the PBA message 711, when a packet for the home prefix P1 is routed to the MAG 202, the MAG 202 can transfer the packet to the WLAN interface If2 with an address configured from the foreign prefix P2.

The following considers problems in Embodiment 5 as compared with Embodiment 1. Firstly, the configurations of the MAGs 201, 202 in the home PMIPv6 domain 204 are changed. Secondly, the MN 200 may want a packet for the home prefix P1 to come to the stable 3G cellular interface If1 only. That is, the MN 200 may not want the packet to come to both of the interfaces If1 and If2. When the MN 200 wants thusly, a notification from the LMA/HA 203 to the MAG 202 about the home prefix P1 will be wasted.

Thirdly, when the MN 200 includes two HoAs (HoA1 configured from the home prefix P1 and HoA2 configured from the foreign prefix P2) in the home PMIPv6 domain 204, the MN 200 may not want an optimization service of this signaling. Herein, the MN 200 and the CN 214 may be equipped with SHIM6 (Site Multi-homing by IPv6 Intermediation). In this case, multihoming can be implemented already, and therefore the operation by the LMA/HA 203 will be wasted. Herein it is obvious for those skilled in the art that ideally the LMA/HA 203 should perform this signaling optimization only after any trigger is acquired from the MN 200. This is because typically the MN 200 only understands a state (a protocol included) of the MN 200 and desired contents. Although the problems in Embodiment 5 are described above, an advantage of Embodiment 5 resides in that there is no need for the MN 200 to execute any signaling in the home PMIPv6 domain 204 so as to implement multihoming. According to Embodiment 5, the MN 200 can receive a packet addressed to the home prefix P1 at all of the interfaces If1 and If2.

### Embodiment 6

Referring to FIG. 12 again, Embodiment 6 is described below. In Embodiment 6, assume that the MN 200 wants a packet of the home prefix P1 to reach both of the interfaces If1 and If2 (or If2). Herein, the MN 200 includes one home prefix P1 and one HoA for the interfaces If1 and If2. The MN 200 notifies the LMA/HA 203 of the home prefix P1, and requests the LMA/HA 203 to make a notification of a MAG 202 relating to the foreign prefix P2 about the home prefix P1. Basically, such notification signaling from the MN 200 is required only once.

The following describes in detail. The MN 200 notifies the LMA/HA 203 of the home prefix P1 and requests the LMA/HA 203 to notify a MAG 202 connecting with the other interface If2 of the MN about the home prefix P1. This notification message is a new type of explicit mobility signaling message. Receiving this notification message, the LMA/HA 203 notifies the MAG 202 that the home prefix P1 is an effective prefix. The LMA/HA 203 can notify the MAG 202 of the prefixes P1 and P2 when the interface If2 of the MN 200 is attached to the MAG 202. Herein, it is important that once the MAG 202 acquires information on the home prefix P1, the MAG 202 can transfer this information to another MAG to which the interface If2 of the MN 200 is attached using CT (context transfer). This CT operation is enabled only when a CT interface is available between the old MAG and the new MAG.

In Embodiment 6, a packet reaching the HoA of the home prefix P1 at the LMA/HA 203 is tunneled via the MAG 202. Every time the interface If2 of the MN 200 moves, the LMA/HA 203 transmits the above-stated notification message about the home prefix P1. Further, although tunneling via the MAG 202 is not preferable for a highly-confidential dataflow, tunneling via the MN 200 is possible. A major advantage of Embodiment 6 resides in that there is no need for the MN 200 to predict that the other interface If2 is attached to the home PMIPv6 domain 204, and there is no need to transmit the interface identifier of the other interface If2 as in Embodiment 1. As compared with Embodiment 1, Embodiment 6 can slightly reduce load on signaling coming from the MN 200.

### Embodiment 7

Referring to FIG. 12 again, Embodiment 7 is described below. In Embodiment 7, assume that the MN 200 wants a packet of the home prefix P1 to reach both of the interfaces If1 and If2 (or If2), and therefore the MN 200 notifies the MAG 202 of the home prefix P1. The MAG 202 acquires verification of the home prefix P1 from the LMA/HA 203.

The following describes in detail. Assume herein that the interface If1 of the MN 200 is already attached to the MAG 201, and refers to the home prefix P1 with a RA message 210. Next, the MN 200 notifies the MAG 202 of the home prefix P1 with a tunnel setup message between the WLAN interface If2 and the MAG 202 during initial attachment. Acquiring information on the home prefix P1, the MAG 202 transmits the information to the LMA/HA 203 with a PBU message 709. Receiving the PBU message 709 from the MAG 202, the LMA/HA 203 notifies the MAG 202 that the foreign prefix P2 and the home prefix P1 are effective prefixes.

Basically, when the MN 200 is attached to each MAG in the home PMIPv6 domain 204 via the WLAN interface If2, the MN 200 has to transmit the above-stated tunnel setup message to each MAG for verification of the home prefix P1. Instead, once the MAG 202 acquires acknowledgement of the home prefix P1 from the LMA/HA 203, the MAG 202 can transfer this information to another MAG using CT. Basically, each MAG can transfer the home prefix P1 and the foreign prefix P2 using CT, and all MAGs attached to the WLAN interface If2 of the MN 200 include an effective home prefix P1 and such a foreign prefix P2. Therefore, a data packet addressed to a flow of the home prefix P1 can be tunneled to each MAG attached to the WLAN interface If2.

In Embodiment 7, since a packet of the home prefix P1 is acquired at both of the interfaces If1 and If2, signaling is generated in a core network. For instance, as for singling to make an inquiry of effectiveness of the home prefix P1 to the LMA/HA 203 and signaling by which the MN 200 always transfers the home prefix P1 when the WLAN interface If2 is attached to the home PMIPv6 domain 204, such signaling is additional signaling. A major advantage of Embodiment 7 resides in that the MN 200 simply needs to notify a MAG of a home prefix P1. This notification is possible with L2 signal. Thus, signaling load generated from the MN 200 to implement signaling optimization can be reduced as compared with Embodiment 1.

### Embodiment 8

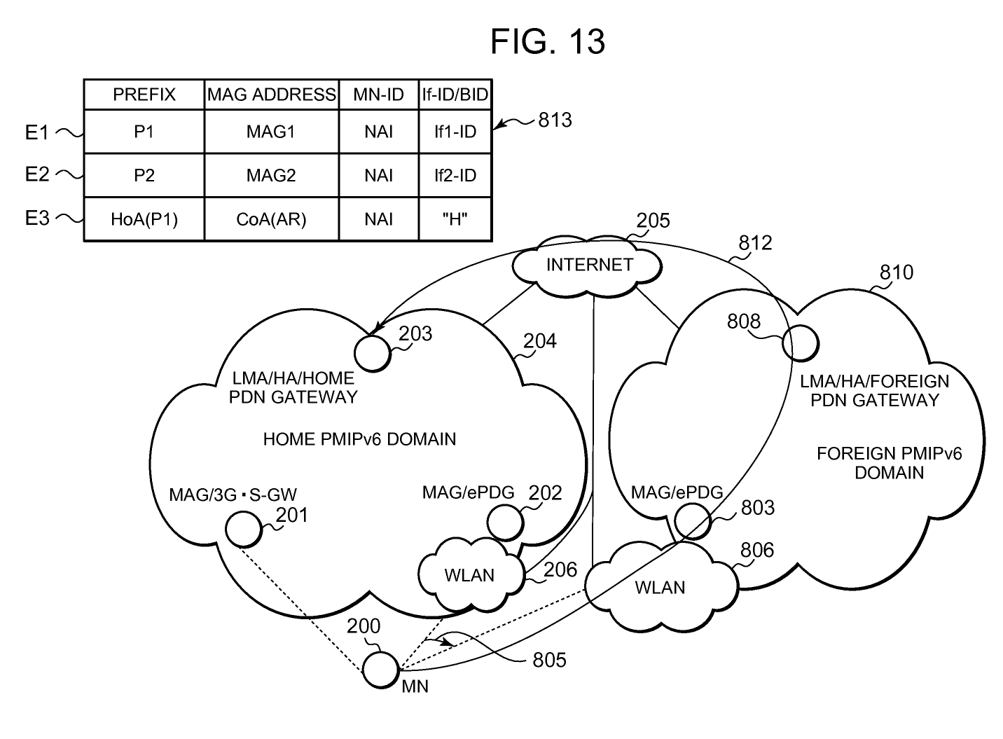

Referring now to FIG. 13, Embodiment 8 is described below. Embodiment 8 describes a method to prevent loss in a packet addressed to a HoA when the MN 200 roams in a foreign PMIPv6 domain 810. Assume herein that the LMA/HA 203 basically can transmit a flow of the home prefix P1 via a MAG to which the foreign prefix P2 is given. Assume further that basically the MAG connecting with the interface If2 of the MN 200 is equipped with a certain function for the home prefix P1 of the MN 200. This function may be provided directly to the MAG by the LMA/HA 203, or may be provided to a certain MAG firstly and be transferred to another MAG using CT.

In FIG. 13, assume that the MN 200 with a plurality of interfaces If1, If2 firstly connects with a home PMIPv6 domain 202 via both of the interfaces If1 and If2. Herein, assume that the MN 200 firstly connects with the MAG 201 via the interface If1 and then connects with the MAG 202 via the interface If2. Assume further that the WLAN 206 with which the MN 200 firstly connects connects with the Internet 205. Assume further that the home PMIPv domain 202 similarly connects with the Internet 205.

When the MN 200 firstly is attached to the MAG 201 via the interface If1, the MAG 201 transmits a PBU message (not illustrated) to the LMA/HA 203 so that a first entry E1 (PMIPv6 cache) is created in a BC 813 of the LMA/HA 203, and the MN 200 refers to the home prefix P1 from a RA message (not illustrated). Next, when the MN 200 triggers tunnel establishment for the MAG 202 via the interface If2, the MAG 202 transmits a PBU message (not illustrated) to the LMA/HA 203 so that a second entry E2 (PMIPv6 cache) is created in the BC 813 of the LMA/HA 203.

Assume herein that the LMA/HA 203 can use the first and the second entries E1 and E2 to tunnel a packet coming to a HoA configured from the home prefix P1 to the MAG 202, and the MAG 202 is notified of the home prefix P1. Assume further that when the MN 200 is still attached to the MAG 201, the WLAN interface If2 is disconnected from the MAG 202 and is attached to a MAG 803 of another foreign PMIPv6 domain 810. At this time, basically the MN 200 refers to a foreign prefix, i.e., a local breakout prefix from a LMA/HA 808 of the foreign PMIPv6 domain 810 via the WLAN interface If2. Then, the MN 200 transmits a CMIPv6-BU message 812 to a home LMA/HA 203 via the foreign PMIPv6 domain 810 so that a third entry E3 (CMIPv6 cache) is created in the BC 813 of the LMA/HA 203.

Herein, it is important that the MN 200 transmits the CMIPv6-BU message 812 with flag H and wants the LMA/HA 203 to transmit a packet addressed to the HoA via the WLAN interface If2. As a case with very low probability, there is a case where the WLAN interface If2 is attached to the LMA/HA 808 of the foreign PMIPv6 domain 810, and after the third entry E3 (CMIPv6 cache) is created in the BC 813 of the LMA/HA 203, registration of the second entry E2 by the MAG 202 is not cancelled but still remains. In this case, packet loss will occur. This is because the LMA/HA 203 can use the second entry E2 to route a packet. Thus, when the MN 200 transmits the CMIPv6-BU message 812, preferably the MN 200 attaches a new option to the BU message 812 so as to make a notification that the second entry E2 is no longer effective. To this end, a foreign prefix P2 can be transmitted in an option of the BU message 812.

When the MN 202 is attached to a WiMAX access network, a MAG function coexists in an access gateway (AGW) located in a wireless access network. When the MN is attached to an untrusted WLAN access network, a MAG function coexists in an ePDG thereof. When the MN is attached via a 3G access such as E-UTRAN, UTRAN, or GERAN, a MAG function coexists in a Serving GateWay (S-GW) thereof. In 3GPP architecture, a LMA/HA function coexists in a Packet data network GateWay (P-GW).

### Embodiment 9

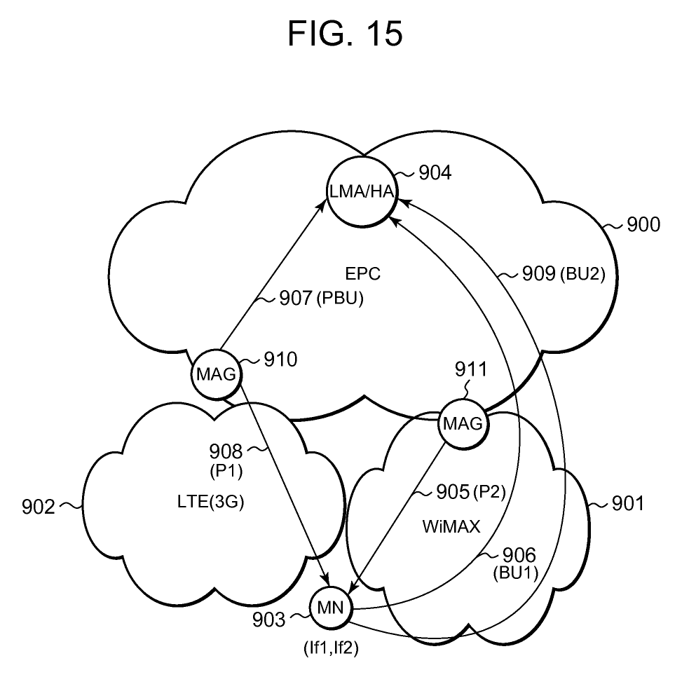

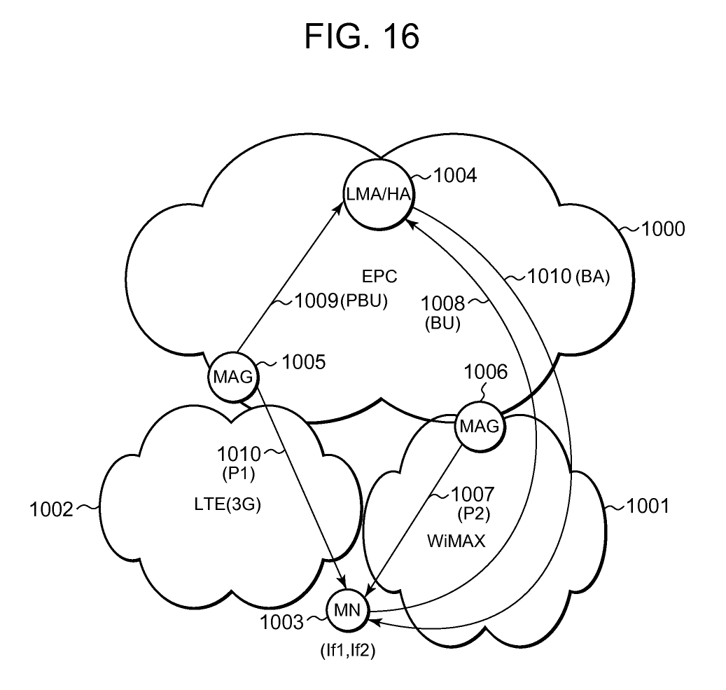

In Embodiment 9, in order to cope with a problem of double reservation (BU1, BU2) illustrated in FIG. 15, a MN requests a LMA/HA to create home and away binding when PMIPv6 bearer is set up. Referring to FIGS. 16 to 23, the following describes Embodiment 9 in detail. Assume in FIG. 16 that a MN 1003 firstly is attached to an EPC (evolved packet core) 1000 as a home domain via a WiMAX interface If2 (and a WiMAX access network 1001 and a MAG 1006), and then is attached to the EPC 1000 via a LTE (long-term evolution) interface If1, i.e., a 3G cellular interface If1 (and an access network 1002 such as UTRAN, LTE, or E-UTRAN, and a MAG 1005).

When the WLAN interface If2 is firstly attached to the WiMAX access network 1001, after authentication by the MAG 1006 is completed, the MN 1003 refers to a prefix P2 managed by the MAG 1006 via a signaling message 1007. Similarly to FIG. 15, mobility of the WiMAX interface If2 is managed by a MIPv6 mechanism. When the MN 1003 starts processing for attachment via the WiMAX interface If2, the MN 1003 starts processing for attachment with the LTE/3G interface If1. When the MN 1003 firstly refers to the prefix P2 via the WiMAX interface If2, the MN 1003 internally predicts a prefix type that will be referred to via the LTE/3G interface If1 from now on, and decides the same. Herein, assume that mobility of the prefix P1 referred to via the LTE/3G interface If1 is managed by a PMIPv6 mechanism.

Based on many factors, the MN 1003 can predict a MIPv6 home prefix P1 referred to via the LTE/3G interface If1 connected with the E-UTRAN access network 1002. As a first factor, since a MIPv6-BU cannot run via the LTE/3G interface If1, that is, a network-based local mobility management protocol is used as described in Non-Patent Document 6, the MN 1003 may predict that a LMA/HA 1004 always assigns a home prefix P1 continuously so that a session can be continued even when a power source of the WiMAX interface If2 is turned off.

As a second factor contributing the above prediction, when the MN 1003 participates in only one service type indicated by one APN (Access Point Name), and WiMAX binding is set up in the LMA/HA 1004, the MN 1003 predicts that the LMA/HA 1004 gives the MIPv6 home prefix P1 via the 3G/LTE interface If1 so as to implement multihoming with respect to the UE 1003. The APN characterizes a certain service type in 3GPP. The APN is described in detail in Non-Patent Document 6. When the MN 1003 participates in only one PDN, only one APN is kept, and therefore it can be predicted rationally that when connection is performed via the LET interface If1, the LMA/HA 1004 may assign the same MIPv6 prefix.

In the case where the MN 1003 participates in a plurality of PDNs, a plurality of APNs are kept. Therefore, the LMA/HA 1004 may assign another prefix via the LTE interface If1 for access to another PDN. Basically, in the assumption with a plurality of APNs, a P-GW may assign a prefix from a different PDN to each interface during simultaneous connection. That is, in order to implement multihoming, a prefix from a PDN1 is assigned via the WiMAX interface If2 and a prefix from a PDN2 is assigned via the 3G interface If1.

As a third factor contributing the above-stated prediction, when the MN 1003 uses a flow concerning real time via the WiMAX interface If2 and switches the same into via the 3G interface If1, a flow from the WiMAX interface If2 preferably passes through on the 3G interface If1 side because the 3G interface If1 is ideal for the real time flow as network policy. When letting this flow pass through on the 3G interface If1 side, the network has to transmit a MIPv6 prefix as a PMIPv6 prefix via the 3G interface If1. When the above-stated network policy is understood, the MN 1003 can easily predict that the MIPv6 home prefix P1 will be referred to via the 3G interface If1.

A fourth factor contributing the above-stated prediction is policy configured statically at the MN 1003. The MN 1003 may configure policy of “wanting to make a LTE link a MIPv6 home link” beforehand at HSS (Home Subscription Server). The MN 1003 configures this static policy because of “wanting to simultaneously use a real time flow”, for example, and configures this policy at the HSS when the MN 1003 participates in a PDN providing a real time service. The PDN providing a real time service is of an IMS (IP Multimedia Service) type. As another reason, there is a case where the MN 1003 wants LTE access to provide better QoS to a real time service so that a real time flow comes to the 3G interface If1.

From the above description, it can be understood that the MN 1003 can use a decision criterion predicting that “the MIPv6 home prefix P1 will be referred to via the 3G interface If1”. Completing this decision process, the MN 1003 transmits a BU message 1008 to the LMA/HA 1004. The BU message 1008 may include new information embedded therein, the information requesting the LMA/HA 1004 to create home and away binding when PMIPv6 bearer is set up for the MIPv6 home prefix P1, for example. Hereinafter the information embedded in the BU message 1008 is called a “home binding creation request” or a “H flag creation request”. A person skilled in the art can predict that the MN 1003 refers to the MIPv6 home prefix P1 via the LTE access, and therefore it is obvious that the MN 1003 may transmit only one BU message 1008 including a home binding creation request instead of a plurality of BU messages (BU1, BU2) illustrated in FIG. 15 as a BU message transmitted to the LMA/HA 1004 to create home and away binding.

The LMA/HA 1004 processes the above-stated “home binding creation request” in the BU message 1008, and transmits a reply message or a BA message 1010 to the MN 1003. The BA message 1010 notifies the MN 1003 that “when PMIPv6 bearer is set up for the MIPV6 home prefix P1, a request requesting to create a H flag is to be supported or not”. The BU message 1008 may further include any information to identify the PMIPv6 bearer in addition to trigger to create the H flag when this PMIPv6 bearer is set up. This identification information may be a parameter such as an interface identifier or an APN (Access Point Name).

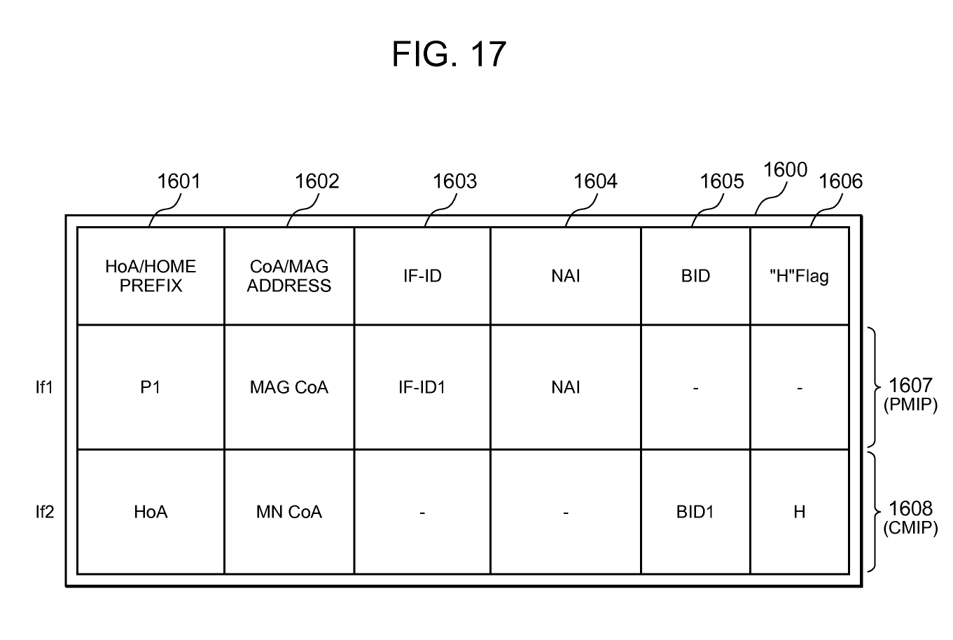

The BU message 1008 may be transmitted as various different types, which is disclosed in the below-described embodiments. Important information embedded in the BU message 1008 is the “home binding creation request” requesting the LMA/HA 1004 to create a H flag in a H flag field of a CMIPv6 cache 1608 illustrated in FIG. 17 when PMIPv6 bearer is set up for the MIPV6 home prefix P1. Additionally the message 1008 may include information requesting to transmit the MIPv6 home prefix P1 as the PMIPv6 prefix via the LTE interface If1 when the LMA/HA 1004 does not have such a mechanism. To request the MIPv6 home prefix P1 as the PMIPv6 prefix thusly is an option. This request depends on policy of the MN 1003 as to whether or not to implement simultaneous binding with respect to a flow of the home prefix P1.

The message 1008 further may include other information to implement home and away binding in the LMA/HA 1004. For instance, the message 1008 may include trigger to request the LMA/HA 1004 to create a BID value of the interface If1 connecting with home. When this BID creation trigger is transmitted with the message 1008, the LMA/HA 1004 creates a BID value for a cache of the PMIPv6 bearer connecting with home. Further, the LMA/HA 1004 guarantees that this BID value is different from a BID value of an interface dealt with by the CMIPv6 mechanism. This BID value created for the interface If1 connecting with home makes it easy to set a filtering rule to the interface If1 connecting with home using the current mechanism. Instead, the MN 1003 may describe a BID option in the message 1008. This BID option is used to indicate a BID value of home binding. Using the BID option, the MN 1003 can describe a BID value of home binding by itself instead of letting the LMA/HA 1004 create the BID value.

Receiving the message 1008, the LMA/HA 1004 processes the message 1008 and waits for a PBU message 1009 for the interface IF1 reaching the LMA/HA 1004. Herein, although the LMA/HA 1004 creates the CMIPv6 binding in an entry 1608 illustrated in FIG. 17, the created CMIPv6 binding does not yet include a H flag inserted therein. When the PBU message 1009 for the interface If1 reaches from the MAG 1005, the LMA/HA 1004 creates the PMIPv6 binding in an entry 1607 illustrated in FIG. 17 while inserting a H flag in the CMIPv6 binding. When the H flag is inserted in the CMIPv6 binding; the MN 1003 can reach via the interface If1 connecting with home and the interface If2 connecting with the foreign domain.

Herein, it is important that the “home binding creation request”, i.e., the “H flag creation request” transmitted via the message 1008 is not active until the PMIPv6 bearer is set up. Once the H flag is inserted by the LMA/HA 1004, the MN 1003 enables a flow addressed to the MIPv6 home prefix P1 to reach via all of the interfaces If1 and If2, so that multihoming can be implemented.

Once the PMIPv6 bearer is set up, the MAG 1005 on the LTE access network 1002 side advertises the home prefix P1 with the message 1010. In the case where the access network 1002 is E-UTRAN, this home prefix P1 is advertised to the MN 1003 succeeding in attaching by a MME (Mobility Management Entity). It is obvious for those skilled in the art that the solution in the present embodiment is applicable also to the case where while the LTE/3G interface If1 is booted up, the WiMAX interface If2 is executing a handoff or in the case where both of the interfaces If1 and If2 are executing mobility simultaneously. When the message 1008 includes information relating to home binding (e.g., a BID option (including HoA in CoA field)), the LMA/HA 1004 applies the information to the created home binding.

### <BCE in LMA/HA>

Referring now to FIG. 17, the following describes a configuration of a binding cache created in the LMA/HA 1004 when the MN 1003 transmits a “H flag insertion request” to the LMA/HA 1004. FIG. 17 illustrates a configuration of a binding cache entry (BCE) 1600 relating to a specific MN 1003 only. Since the LMA/HA 1004 is equipped with a home agent function and a local mobility anchor function, the BCE 1600 created for the MN 1003 conceivably includes both of a PMIPv6 cache and a CMIPv6 cache. It is obvious for those skilled in the art that the BCE 1600 includes binding cache entries for a large number of MNs to which the LMA/HA 1004 provides a service. This configuration of the binding cache is very specific.

When the LMA/HA 1004 is not notified of a multihoming parameter with the BU message 1008, it can be considered generally that a CMIPv6 entry takes precedence over a PMIPv6 entry. As illustrated in FIG. 17, however, when a binding cache is created using an appropriate multihoming parameter such as H flag and/or a BID option, the binding cache entries 1608 and 1607 of CMIPv6 and PMIPv6 have the same priority, so that a flow addressed to the MN 1003 can be routed using any one of the entries 1608 and 1607.

A first field 1601 in the BCE 1600 of FIG. 17 indicates a home network prefix (home prefix) P1 relating to the MN 1003 or a home address (HoA). The home network prefix P1 typically relates to PMIPv6 binding (1607 of FIG. 17), and the home address (HoA) typically relates to CMIPv6 binding (1608 of FIG. 17). Herein, CMIPv6 binding may relate to the home network prefix P1 as well. A second field 1602 indicates an egress address (MAG CoA) of the MAG 1005 when the field 1602 is created from a PMIPv6 entry 1607. A field 1602 created from a CMIPv6 entry 1608 indicates a CoA (MN CoA) relating to an interface of the MN 1003. A third field 1603 indicates an identifier of an interface (IF-ID) of the MN 1003. Herein, the field 1603 can indicate a MAC address or an interface identifier given to a specific interface. The field 1603 of IF-ID is essential in the case of PMIPv6 binding, but is not used in the case of CPMIPv6 binding.

The next field 1604 indicates a network access identifier (NAI) of the MN 1003, and this NAI may be a temporary identifier or a permanent identifier. The field 1604 of NAI is essential in the case of PMIPv6 binding, but is not essential in the case of CPMIPv6 binding. The next field 1605 indicates a binding identifier (BID) of specific binding, which is used to identify specific binding relating to a specific home address. The last field 1606 indicates a H flag relating to the CMIPv6 entry 1608.

In the case where when a “home binding creation request” reaches the LMA/HA 1004, PMIPv6 bearer is not established yet, the LMA/HA 1004 does not insert a H flag into the H flag field 1606 of the CMIPv6 entry 1608. The LMA/HA 1004 stands by until a PMIPv6 cache is created, and when the PMIPv6 cache is created, the LMA/HA 1004 inserts a H flag into the H flag field 1606 of the CMIPv6 entry 1608. In the case where PMIPv6 bearer is established already, when a CMIPv6 request to create a H flag reaches, then the LMA/HA 1004 creates a CMIPv6 entry 1608 with H flag.

It is obvious for those skilled in the art that a lot of methods are available to enable the MN 1003 to create simultaneous registration of home and away in the LMA/HA 1004. For instance, a H flag can be associated with PMIPv6. Instead, a BID option value in the field 1605 can indicate simultaneous registration of home and away.

### <Packet Configuration of H Flag Creation Request Message>

Various methods are available as a method to transmit a “home binding creation request” described in the present embodiment. In the above-described embodiment, the “home binding creation request” that instructs the LMA/HA 1004 to insert a H flag in a CMIPv6 cache when PMIPv6 bearer for home prefix P1 is set up is implemented with a new option in the BU message 1008. However, many modification examples can be considered. The following describes them in detail.

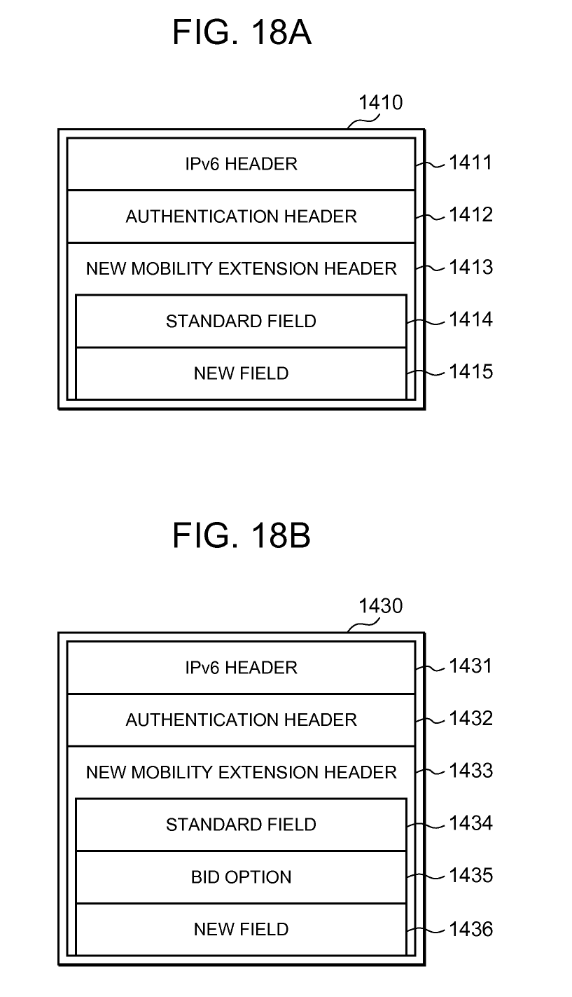

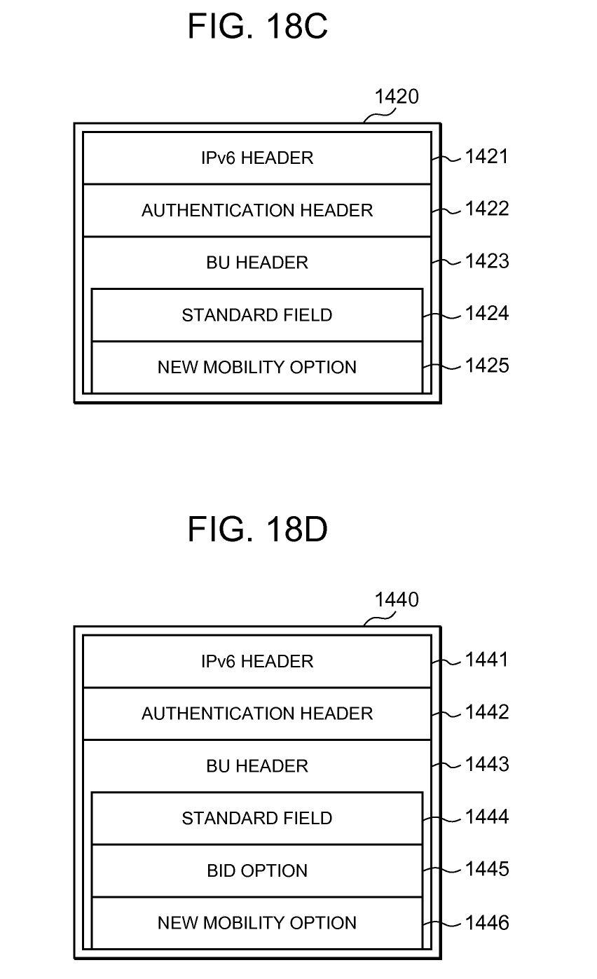

Referring now to FIG. 18A, FIG. 18B, FIG. 18C and FIG. 18D, other signal configurations including a “home binding creation request”, i.e., a “H flag insertion request” are described below. In FIG. 18A and FIG. 18B, the “H flag insertion request” is transmitted with a new mobility header type. A packet 1410 illustrated in FIG. 18A includes fields of an IPv6 header 1411, an authentication header 1412 and a new mobility extension header 1413, where the field of the new mobility extension header 1413 includes a standard field 1414 and a new field 1415 indicating a “H flag insertion request”. A packet 1430 illustrated in FIG. 18B includes fields of an IPv6 header 1431, an authentication header 1432, and a new mobility extension header 1433, where the field of the new mobility extension header 1433 includes a standard field 1434, a field of a BID option 1435, and a new field 1436 indicating a “H flag insertion request”. Herein, as a signal, an IKEv2 message can be used, which are performed when the MN 1003 connects with a network.

In FIG. 18C and FIG. 18D, a “H flag insertion request” is transmitted with a normal BU header type. A packet 1420 illustrated in FIG. 18C includes fields of an IPv6 header 1421, an authentication header 1422, and a BU header 1423, where the BU header 1423 includes fields of a standard field 1424 and a new mobility option 1425. The field of the new mobility option 1425 includes a “H flag insertion request” and an interface identifier to identify PMIPv6 bearer. A packet 1440 illustrated in FIG. 18D includes fields of an IPv6 header 1441, an authentication header 1442, and a BU header 1443, where the field of the BU header 1443 includes fields of a standard field 1444, a field of a BID option 1445, and a new mobility option 1446 indicating a “H flag insertion request”. A sender address in the IPv6 headers 1411, 1421, 1431 and 1441 is CoA of the MN 1003, and a destination address thereof is an address of the LMA/HA 1004 as a home agent of the MN 1003.

That is a description of various packet configurations to transmit a “H flag insertion request”. However, there are still other methods available. Instead of transmitting with a new option or a new field, a “H flag insertion request” can be transmitted with a new flag. Further, a “H flag insertion request” can be transmitted also with a new BID value put on hold. The new BID value has been put on hold so as not to be used for other plurality of CoA bindings, which is advertised globally.

As another method, a “H flag insertion request” may be notified to the MAG 1005 as a proxy node of the MN 1003 from the MN 1003 with a signal of the L2 frame 307B illustrated in FIG. 6A in Embodiment 1. In this case, the MN 1003 can use a PCO (Protocol Configuration Option). The MAG 1005 notifies the LMA/HA 1004 of this “H flag insertion request” with a PCO in the PBU message 1009, a new option or a new flag. Referring to this PCO, the new option, or the new flag, the LMA/HA 1004 inserts a H flag into a CMIPv6 cache when a PMIPv6 bearer for home prefix P1 is set up. As the signal, a message specific to an access network may be used.

The field of the protocol ID 303B in the L2 frame 307B illustrated in FIG. 6A includes a value only in the case of a packet generated at an upper layer than L2. The value of the protocol ID 303B is all 0 when the “H flag insertion request” is generated at L2. However, even when the “H flag insertion request” is generated at L2, a decision to transmit the “H flag insertion request” and a related parameter embedded in the L2 frame 307B have to come from L3. The “H flag insertion request” is transmitted with the field of the information 304B. As an option, the field of the information 304B may transmit a BID of a CMIPv6 binding. The “H flag insertion request” may be transmitted with frame configurations other than the L2 frame 307B illustrated in FIG. 6A.

The MN 1003 may notify the MAG 1005 as a proxy node of the MN 1003 of a request inserting a BID into a CMIPv6 cache (BID insertion request) with the L2 frame 307B illustrated in FIG. 6A. This BID can be given by the MN 1003 or created by the MAG 1005. Instead, the MAG 1005 may establish association of a special flag in the PBU message 1009 so as to request the LMA/HA 1004 to use an interface identifier as the BID of the CMIPv6 cache. Herein it is important that when a L2 message is used, the CMIPv6-BU message 1008 transmitted for the WiMAX interface If2 does not include trigger to insert a H flag when PMIPv6 bearer is set up.

### <Configuration of MN>

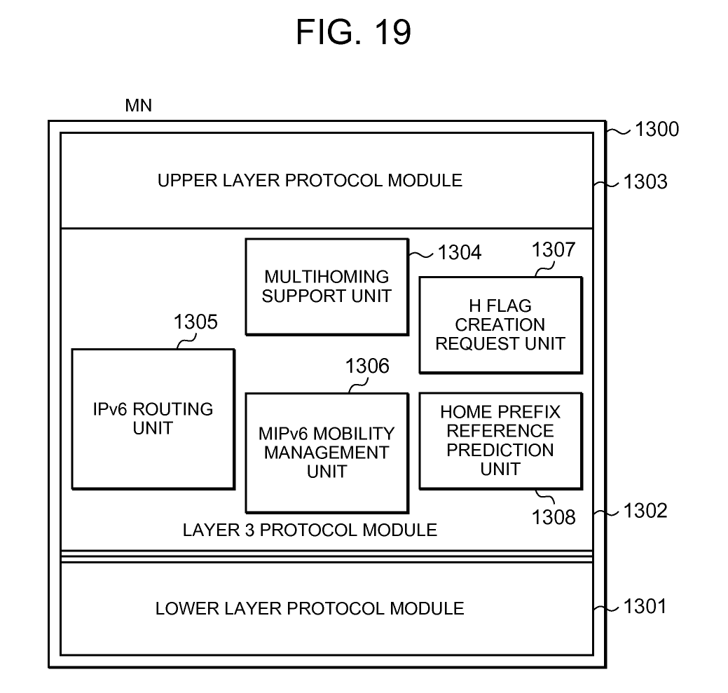

FIG. 19 is a block diagram illustrating functional architecture 1300 to describe the configuration of the MN 1003 in Embodiment 9. The functional architecture 1300 includes all software, hardware, and firmware that the MN 1003 has to include. The functional architecture 1300 is made up of three sub-modules, specifically including a lower layer protocol module 1301, a layer 3 protocol module 1302, and an upper layer protocol module 1303.

The lower layer protocol module 1301 is made up of a plurality of lower layer protocol modules related to the interfaces If1 and If2 of the MN 1003, and these lower layer protocol modules mainly relate to control and transmission mechanisms of a link layer. The layer 3 (L3) protocol module 1302 includes five sub-modules, i.e., a multihoming support unit 1304, an IPv6 routing unit 1305, a MIPv6 mobility management unit 1306, a H flag creation request unit 1307, and a home prefix reference prediction unit 1308. The L3 protocol module 1302 further includes a not-illustrated interface to exchange a message among the respective units 1304 to 1308. The respective units 1304 to 1308 include a related binding list if required.

The IPv6 routing unit 1305 runs neighbor discovery, address configuration and basic IPv6 routing mechanism, and the MIPv6 mobility management unit 1306 runs a MIPv6 mobility management function such as update of binding and registration cancellation. The multihoming support unit 1304 runs a plural registration function such as creation of a BID in a BU message and attachment of a H flag. The H flag creation request unit 1307 is equipped with a function to configure a “home binding creation request” requesting the LMA/HA 1004 to create a H flag when PMIPv6 bearer for home prefix P1 is set up. The home prefix reference prediction unit 1308 is equipped with a function to predict home prefix reference based on various many factors. The prediction of the home prefix reference has been described in detail. It is obvious for those skilled in the art that the respective units 1304 to 1308 require an appropriate software interface for implementation.

Finally, the upper layer protocol module 1303 is equipped with a function of an upper layer protocol such as a transport layer and an application layer included in the MN 1003. It is obvious for those skilled in the art that the functional module illustrated in FIG. 19 is just one example, and various other methods for embodiment are available unless they do not depart from the scope and the spirit of the present invention.

### <Operation of MN>

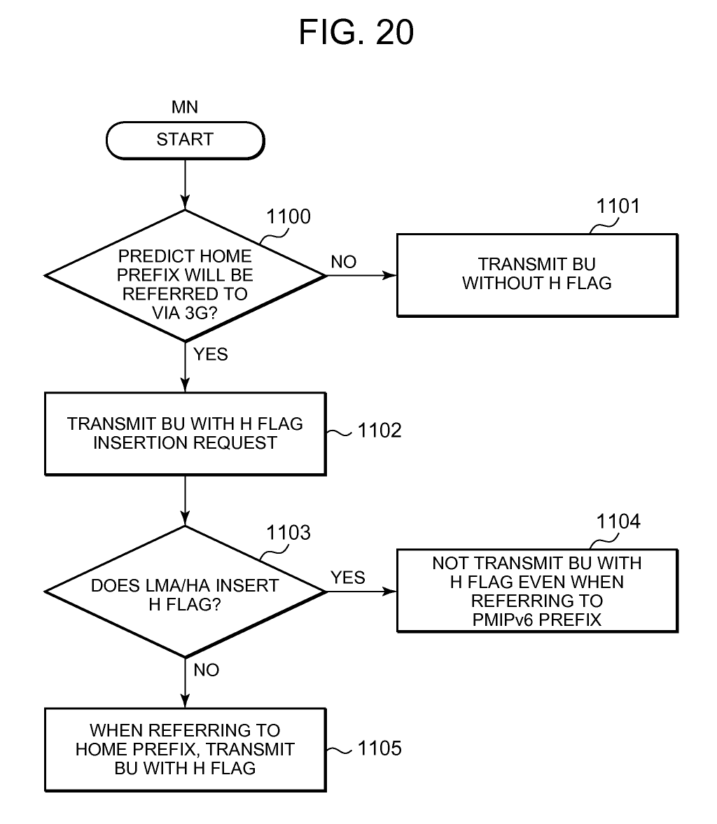

Referring next to a flowchart illustrated in FIG. 20, an operation by the MN 1003 (called a UE (User Equipment) in 3GPP) is described below. The MN 1003 firstly runs Step 1100 to predict whether a home prefix P1 might be referred to via a 3G interface If1 or not. Since this prediction process has been described in detail, the description thereof is not repeated. In the case of NO in determination at Step 1100, that is, in the case where the MN 1003 cannot predict with a high probability that the home prefix P1 is referred to via the 3G interface If1, the procedure proceeds to Step 1101, where a normal operation, i.e., a BU message without H flag is transmitted. At Step 1101, a normal BU message for a WiMAX interface If2 is transmitted, to which a parameter relating to multihoming is not attached, nor in which a new option is embedded.

On the other hand, in the case of YES in determination at Step 1100, the MN 1003 transmits a new BU message 1008 with a “home binding creation request” attached thereto to the home agent (LMA/HA) 1004, thus requesting the LMA/HA 1004 to insert a H flag into the CMIPv6 entry 1608 when PMIPv6 bearer for home prefix P1 is set up. After the MN 1003 transmits this new (i.e., including a new option) BU message 1008 at Step 1102, the MN 1003 waits for an ACK signal (BA message 1010) as a reply from the HA.

Receiving the ACK signal, the MN 1003 checks the ACK signal so as to check whether it includes a “reply to let the LMA/HA 1004 set a H flag when PMIPv6 bearer for home prefix P1 is set up” (Step 1103). In the case where the HA sets H flag (YES at Step 1103), the MN 1003 decides not to transmit a BU message with H flag (909 illustrated in FIG. 15) to the LMA/HA 1004 even when the MN 1003 refers to the home prefix P1 via a LTE interface If1 (Step 1104). In the case of NO at Step 1103, this is either a case where the LMA/HA 1004 does not accept the BU message 1008 that MN 1003 transmits at Step 1102, or a case where the LMA/HA 1004 does not want to give a MIPv6 home prefix P1 via the LTE interface Ill. In such a case, the MN 1003 returns to a normal operation to stand by until the home prefix P1 is referred to, and when the home prefix P1 is referred to, the MN 1003 transmits a BU message with H flag (909 illustrated in FIG. 15) set in the BID option to the HA (Step 1105).

### <Processing by LMA/HA>

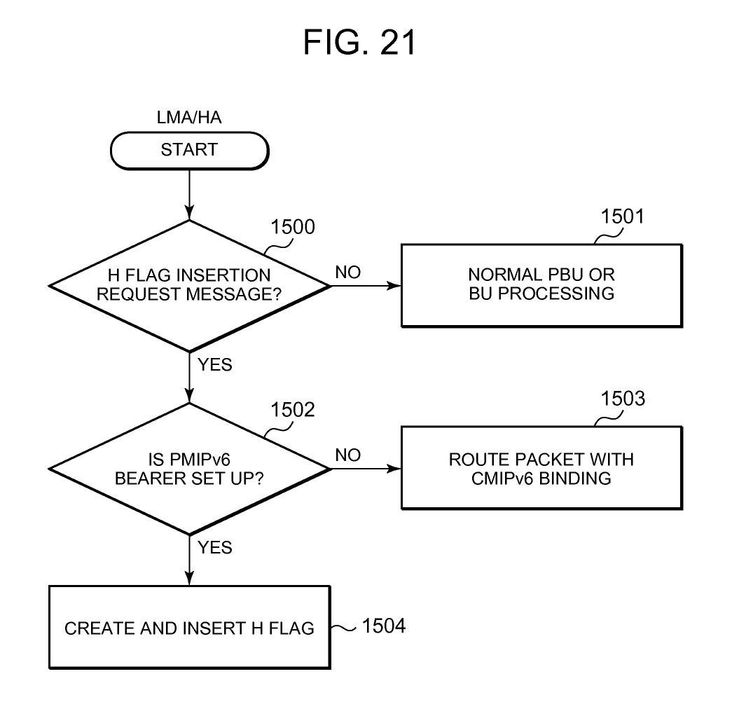

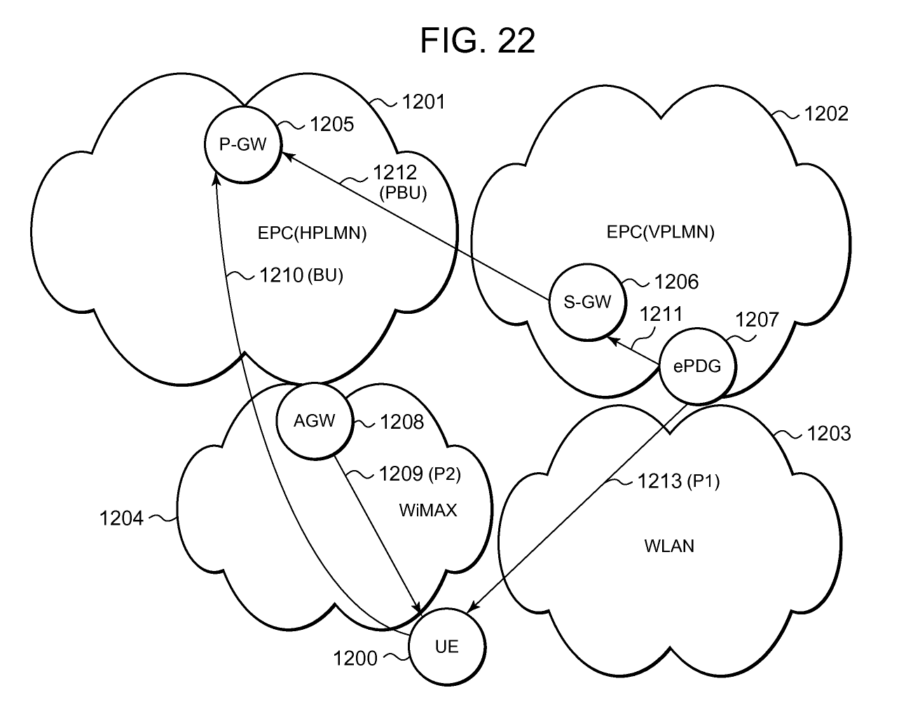

Referring next to FIG. 21, processing by the LMA/HA 1004 is described below. Although the configuration of the LMA/HA 1004 in Embodiment 9 is not illustrated, the functional configuration thereof is substantially the same as that of FIG. 10 in Embodiment 1, and therefore the illustration thereof is omitted. In FIG. 21, at a first Step 1500, the LMA/HA 1004 checks whether a received message is a new type of message or not (BU message 1008, hereinafter called a “H flag insertion request message”) requesting to insert a H flag when PMIPv6 binding for home prefix P1 is created. In the case of NO at Step 1500, the LMA/HA 1004 executes processing of another standard signaling message such as a PBU or BU message as a normal operation at Step 1501.

On the other hand, in the case of YES at Step 1500, at Step 1502 the LMA/HA 1004 checks whether PMIPv6 binding (entry 1607) is set up or not at the time when the H flag insertion request message reaches. In the case of NO at Step 1502, the procedure proceeds to Step 1503. In this case, conceivably although the CMIPv6 binding (entry 1608) is firstly created, a flag is inserted therein when PMIpv6 bearer of the LMA/HA 1004 is set up. Therefore, at Step 1503, the LMA/HA 1004 routes a packet using CMIPv6 binding of the entry 1608. On the other hand, in the case of YES at Step 1502, since the PMIPv6 bearer of the LMA/HA 1004 has been set up already, the LMA/HA 1004 creates a CMIPv6 cache with H flag in the entry 1608 at Step 1504.

### Another Assumed Example in Embodiment 9

FIG. 22 assumes a system where chained scenario is to be formed between 3GPP networks. In this 3GPP chained scenario system, a S-GW (Serving GateWay) 1206 in a EPC (VPLMN) 1201 as a foreign domain operates as a mobility management anchor on the way of a path with respect to a MN (UE 1200). In this assumption, an ePDG 1207 as a MAG attached to the UE 1200 transmits a binding parameter relating to an address of the P-GW (Packet data network GateWay) 1205 to the S-GW 1206 as the management anchor on the way of a path. Further the S-GW 1206 transmits the received binding parameter to the P-GW 1205 and creates PMIPv6 binding at the P-GW 1205.

3GPP implements mobility management using the above-stated chained scenario architecture when the UE 1200 is located in a VPLMN 1202 and a node managing a prefix is the P-GW 1205 located at the HPLMN 1201. When the above-stated mobility management anchor on the way of a path does not exist, a new PMIPv6-BU message has to be transferred from the VPLMN 1202 to the HPLMN 1201 every time the UE connects with a MAG, thus causing handoff delay. When the UE 1200 is located at the VPLMN 1202 and the S-GW 1206 does not change when UE 1200 changes a MAG, there is no need for such a S-GW 1206 to transmit a binding parameter to the P-GW 1205, so that high-speed mobility management can be implemented for the UE 1200 located at the VPLMN 1201. The details of the assumption for 3GPP chained scenario are described in Non-Patent Document 6.

A system for 3GPP chained scenario is described below in detail. A major object of this assumed example is to show delay of home prefix P1 in very practical network architecture of 3GPP. In FIG. 22, the UE 1200 connects with the EPC (Evolved Packet Core) 1201 that is a 3GPP core network and an HPLMN (Home Public Land Mobile Network) of the UE 1200 as well via two interfaces of a WiMAX interface and a WLAN interface. Conceivably the UE 1200 further configures the P-GW 1205 of the EPC 1201 as a home agent. Assume further that in the UE 1200 the WiMAX interface is attached via a WiMAX access network 1204 and the WLAN interface is attached via a WLAN access network 1203 and the EPC 1202 that is a VPLMN (visited public land mobile network). As is evident from FIG. 22, the WLAN interface connects with the 3GPP chained scenario architecture. Further conceivably, mobility of the WiMAX interface is managed by MIPv6 mechanism, and mobility of the WLAN interface is managed by PMIPv6 mechanism. In such an assumed example, the UE 1200 wants to implement multihoming by simultaneous connection.

When the WiMAX interface is attached to the WiMAX access network 1204, in order to configure a CoA after the completion of access authentication, the UE 1200 acquires a prefix P2 routed to an access gateway (AG) 1208 with a prefix advertisement message 1209. Further, assume that the UE 1200 starts attachment processing via the WLAN interface. However, after success in the authentication and the authorization of the WLAN access, the ePDG 1207 on the VPLMN 1202 side transmits a binding parameter to the S-GW 1206 (signaling message 1211), and the S-GW 1206 further transmits PMIPv6 binding to the P-GW 1205 on the HPLMN 1201 side (PBU message 1212).

In the above-stated assumption for 3GPP chained scenario, it takes some degree of time for chaining process to set up the entire PMIPv6 bearer. In FIG. 22, when the UE 1200 refers to a prefix (called P2) from the AGW 1208, the UE 1200 does not yet refer to a PMIPv6 prefix (called home prefix P1) via the WLAN interface.

In FIG. 22, when the UE 1200 predicts that the home prefix P1 might be referred to via the WLAN interface, the UE 1200 transmits a BU message 1210 including a “home binding creation request” to the P-GW 1205. Assume herein that the P-GW 1205 firstly refers to the BU message 1210 to create a CMIPv6 cache without H flag, and when receiving a PBU message 1212 from the S-GW 1212, the P-GW 1205 inserts the H flag into the CMIPv6 cache. Herein, it is obvious for those skilled in the art that when a BU message 1210 is firstly received from the UE 1200 prior to the PBU message 1212 from the S-GW 1212, the P-GW 1205 can create home and away binding of the UE 1200.

### Still Another Assumed Example in Embodiment 9

### The Case where an Interface Connecting with Home Performs a Handoff

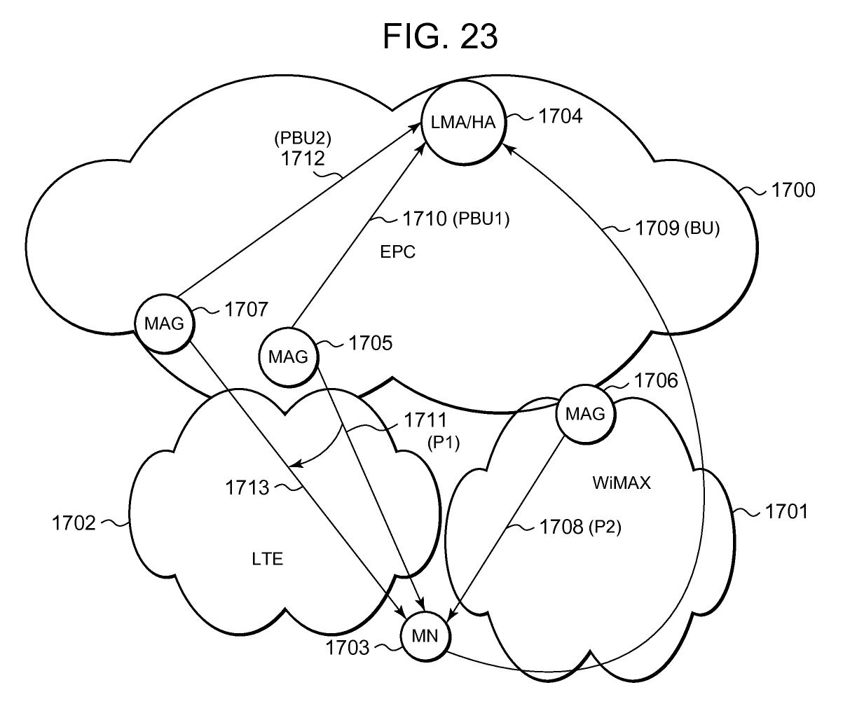

In the above assumption for home and away simultaneous registration, CMIPv6 binding and PMIPv6 binding have to be performed simultaneously. The following describes as a modification example the case where a “home binding creation request” deals with a handoff of an interface connecting with home. Herein, an interface externally connecting is still connecting with the same access router. The following is a detailed description with reference to FIG. 23. A MN 1703 includes two interfaces, for instance a WiMAX interface conceivably connecting with a MAG 1706 via a WiMAX access network 1701. Assume herein that a LTE interface firstly connects with a MAG 1705 via a LTE access network 1702, and next, as a result of movement of the MN 1703, connects with another MAG 1707. Assume further that the MN 1703 connects with the MAG 1705 and the MAG 1707 via a 3G LTE access network 1702.

In the above-stated case, before referring to a home prefix P1 with a message 1711 from the MAG 1705 before handoff, the MN 1703 creates a CoA using a prefix P2 given with a router advertisement message 1708 from the MAG 1706 on the WiMAX side, and transmits a “home binding creation request” to a LMA/HA 1704 with a BU message 1709. Next, when a PMIPv6-PBU message 1710 (PBU1) from the MAG 1705 before handoff reaches the LMA/HA 1704, a H flag is inserted into a CMIPv6 binding cache at the LMA/HA 1704.

Herein, the BU message 1709 including the “home binding creation request” includes new information to notify the LMA/HA 1704 not to delete home and away registration even when a PMIPv6-PBU message 1712 of handoff (PBU2) does not include a multihoming parameter such as BID or H flag. According to Non-Patent Document 5, in the case of a horizontal handoff, a handoff instruction option (option value=3) is included in the PBU messages 1710, 1712. Therefore, when the LTE interface If1 connecting with home of the MN 1703 moves to another MAG 1707, the PMIPv6-PBU message 1712 (PBU2) transmitted from the MAG 1707 to the LMA/HA 1704 will include a horizontal handoff instruction, and will not include a multihoming parameter. In this case, since the BU message 1709 including the “home binding creation request” includes the above-stated new information, the PMIPv6-PBU message 1712 (PBU2) does not overwrite a home and away state at the LMA/HA 1704, and does not delete the home and away registration. The home and away state can be deleted only when the MN 1703 explicitly indicates to the LMA/HA 1704 so as to delete registration of an interface connecting with home or externally. The registration cancellation of the interface connecting with home is performed by PMIPv6 mechanism, and the registration cancellation of the interface connecting externally is performed by CMIPv6 mechanism.

Information on the home and away simultaneous connection may be transmitted as new trigger to a new MAG 1707 after handoff. As this new trigger, a message specific to L2 or a message specific to L3 such as a message relating to neighbor discovery can be used. When the new trigger relating to home and away is transmitted to the MAG 1707, the MAG 1707 transmits this information to the LMA/HA 1704 with the PBU message 1712 (PBU2) of handoff. This home and away information in the PBU message 1712 (PBU2) of handoff allows home and away binding at the LMA/HA 1704 to be maintained even in the above-stated assumed example for the handoff.

That is the description of the most practical and preferable embodiments. However, it is obvious for those skilled in the art that configurations and parameters can be modified variously within a range without departing from the scope and the spirit of the present invention. For instance, although the above-description deals with 3G and WiMAX interfaces, for example, the present invention is applicable also to the case where other different access technique types are included, and an interface of such an access technique type is attached to a network. Although the above-stated assumed examples relate to 3GPP, problems and solutions therefor described in the present specification are applicable to all other SDOs configured with different types of access networks and to limit the use of a certain mobility management mechanism via a certain access technical type.

That is the description of the present invention by way of embodiments. However, it is obvious for those skilled in the art that various modifications are available without departing from the present invention. For instance, each functional block used in the description of the above-stated embodiments may be typically implemented as a LSI that is an integrated circuit. These blocks may be individually configured as one chip, or one chip may include a part or all of the functional blocks. LSIs may be called an IC, a system LSI, a super LSI, and an ultra LSI depending on the degree of integration. A technique for integrated circuit is not limited to a LSI, but an integrated circuit may be achieved using a dedicated circuit or a general-purpose processor. A FPGA (Field Programmable Gate Array) capable of programming after manufacturing a LSI and a reconfigurable processor capable of reconfiguring connection and setting of a circuit cell inside a LSI may be used. Further, if a technique for integrated circuit that replaces LSIs becomes available by the development of a semiconductor technique or derived techniques, functional blocks may be naturally integrated using such a technique. For instance, biotechnology may be applied thereto.

According to the present invention, the invention as follows is provided as recited in claims.

(1) In the binding cache creating method according to claim 1 or in the binding cache creating system according to claim 5, when duration of the first proxy binding cache for the first interface expires, the home agent deletes the client-based binding cache for the second interface.

(2) In the binding cache creating method according to claim 1 or 2 or in the binding cache creating system according to claim 5 or 6, after the first proxy binding cache for the first interface is registered with the home agent, the mobile node transmits a request message to the home agent, the request message requesting to create a client-based binding cache for the second interface and maintain the client-based binding cache, and

after the home agent receives the request message and when the second proxy binding cache for the second interface is registered, the home agent creates a client-based binding cache for the second interface relating to the first and the registered second proxy binding caches, while notifying the mobile node so as not to transmit the request message again.

(3) In the binding cache creating method according to claim 1 or 2 or in the binding cache creating system according to claim 5 or 6, when the home agent receives a proxy binding update message to register the second proxy binding cache for the second interface, the home agent create the second proxy binding cache, while creating a client-based binding cache for the second interface relating to the first and the created second proxy binding caches and notifying the mobile node so as not to transmit a request message requesting to register the client-based binding cache.

(4) In the binding cache creating method according to claim 16, information to create the client-based binding cache for the second interface is transferred between proxy nodes of the home domain.

(5) In the binding cache creating method according to any one of claims 1 to 4 and 14 to 17, when the mobile node roams from the home domain into a foreign domain, the mobile node notifies the home agent of a request to create the client-based binding cache for the second interface via the foreign domain.

### INDUSTRIAL APPLICABILITY

The present invention has an advantage of, when a mobile node with a plurality of interfaces roams in a home domain, reducing signaling to create a client-based binding cache in a home agent and manage the same, and is applicable when the home domain is a 3G PMIPv6 domain, for example.

The present invention further has an advantage of reducing signaling for binding registration when a mobile node with a plurality of interfaces connects with a home link and a foreign link simultaneously, and is applicable when a home domain is a 3G PMIPv6 domain, for example.

1. A binding cache creating method when a mobile node with a first interface capable of communicating with a home domain and a second interface capable of communicating with a local domain roams in the home domain, comprising:
a step of, when the first interface of the mobile node is attached to the home domain, registering a first proxy binding cache for the first interface with a home agent of the home domain;
a step of, when the second interface of the mobile node is attached to the home domain via the local domain, registering a second proxy binding cache for the second interface with the home agent; and
a step where the home agent creates a client-based binding cache for the second interface relating to the first and the second proxy binding caches and maintains the created client-based binding cache without being refreshed by the mobile node.

2. The binding cache creating method according to claim 1, wherein when duration of the first proxy binding cache for the first interface expires, the home agent deletes the client-based binding cache for the second interface.

3. The binding cache creating method according to claim 1, wherein
after the first proxy binding cache for the first interface is registered with the home agent, the mobile node transmits a request message to the home agent, the request message requesting to create a client-based binding cache for the second interface and maintain the client-based binding cache, and
after the home agent receives the request message, and when the first and the second proxy binding caches for the first and the second interfaces are registered, the home agent creates a client-based binding cache for the second interface relating to the registered second proxy binding cache, while notifying the mobile node so as not to transmit the request message again.

4. The binding cache creating method according to claim 1, wherein
when the home agent receives a proxy binding update message to register the second proxy binding cache for the second interface, the home agent creates the second proxy binding cache, while creating a client-based binding cache for the second interface relating to the first and the created second proxy binding caches, and notifies the mobile node so as not to transmit a request message to register the client-based binding cache.

5. A binding cache creating system wherein a mobile node with a first interface capable of communicating with a home domain and a second interface capable of communicating with a local domain roams in the home domain, comprising:
means that, when the first interface of the mobile node is attached to the home domain, registers a first proxy binding cache for the first interface with a home agent of the home domain;
means that, when the second interface of the mobile node is attached to the home domain via the local domain, registers a second proxy binding cache for the second interface with the home agent; and
means that makes the home agent create a client-based binding cache for the second interface relating to the first and the second proxy binding caches and maintain the created client-based binding cache without being refreshed by the mobile node.

6. The binding cache creating system according to claim 5, wherein when duration of the first proxy binding cache for the first interface expires, the home agent deletes the client-based binding cache for the second interface.

7. The binding cache creating system according to claim 5, wherein
after the first proxy binding cache for the first interface is registered with the home agent, the mobile node transmits a request message to the home agent, the request message requesting to create a client-based binding cache for the second interface and maintain the client-based binding cache, and
after the home agent receives the request message and when the second proxy binding cache for the second interface is registered, the home agent creates a client-based binding cache for the second interface relating to the first and the registered second proxy binding caches, while notifying the mobile node so as not to transmit the request message again.

8. The binding cache creating system according to claim 5, wherein
when the home agent receives a proxy binding update message to register the second proxy binding cache for the second interface, the home agent create the second proxy binding cache, while creating a client-based binding cache for the second interface relating to the first and the created second proxy binding caches and notifying the mobile node so as not to transmit a request message requesting to register the client-based binding cache.

9. A home agent in a binding cache creating system wherein a mobile node with a first interface capable of communicating with a home domain and a second interface capable of communicating with a local domain roams in the home domain, comprising:
means that, when the first interface of the mobile node is attached to the home domain, registers a first proxy binding cache for the first interface;
means that, when the second interface of the mobile node is attached to the home domain via the local domain, registers a second proxy binding cache for the second interface; and
means that creates a client-based binding cache for the second interface relating to the first and the second proxy binding caches and maintains the created client-based binding cache without being refreshed by the mobile node.

10. The home agent according to claim 9, wherein when duration of the first proxy binding cache for the first interface expires, the client-based binding cache for the second interface is deleted.

11. A mobile node in a binding cache creating system, the mobile node including a first interface capable of communicating with a home domain and a second interface capable of communicating with a local domain, and the mobile node roaming in the home domain, comprising:
means that, when a first proxy binding cache for the first interface is registered with a home agent of the home domain, transmits a request message to the home agent, the request message requesting to create a client-based binding cache for the second interface relating to first and second proxy binding caches for the first and the second interfaces and maintain the client-based binding cache.

12. A home agent of a home domain in a binding cache creating system, wherein a mobile node with a first interface capable of communicating with the home domain and a second interface capable of communicating with a local domain roams in the home domain, and when a first proxy binding cache for the first interface is registered with the home agent, the mobile node transmits a request message to the home agent, the request message requesting to create a client-based binding cache for the second interface relating to first and second proxy binding caches for the first and the second interfaces and maintain the client-based binding cache, comprising:
means that, after receiving the request message and when a second proxy binding cache for the second interface is registered, creates a client-based binding cache for the second interface relating to the first and the registered second proxy binding caches, and notifies the mobile node so as not transmit the request message again.

13. The home agent according to claim 9, wherein when receiving a proxy binding update message to register the second proxy binding cache for the second interface, the home agent creates the second proxy binding cache, while creating a client-based binding cache for the second interface relating to the first and the created second proxy binding caches, and notifying the mobile node so as not to transmit a request message to register the client-based binding cache.

14. A binding cache creating method when a mobile node with a first interface capable of communicating with a home domain and a second interface capable of communicating with a local domain roams in the home domain, comprising the steps of:
a step of, when the first interface of the mobile node is attached to the home domain, registering a first proxy binding cache for the first interface with a home agent of the home domain;
a step of, when the second interface of the mobile node is attached to the home domain via the local domain, registering a second proxy binding cache for the second interface with the home agent; and
a step where the mobile node requests the home agent to create a client-based binding cache for the second interface relating to the first and the second proxy binding caches and maintain the created client-based binding cache without being refreshed by the mobile node for duration longer than a usual time period.

15. A binding cache creating method when a mobile node with a first interface capable of communicating with a home domain and a second interface capable of communicating with a local domain roams in the home domain, comprising the steps of:
a step of, when the first interface of the mobile node is attached to the home domain, registering a first proxy binding cache for the first interface with a home agent of the home domain;
a step of, when the second interface of the mobile node is attached to the home domain via the local domain, registering a second proxy binding cache for the second interface with the home agent;
a step where the mobile node requests the home agent to create a client-based binding cache for the second interface relating to the first and the second proxy binding caches registered with the home agent; and
a step where the home agent creates the requested client-based binding cache and sets duration longer than a usual time period thereto, while notifying the mobile node so as not to refresh the created client-based binding cache for the duration.

16. A binding cache creating method when a mobile node with a first interface capable of communicating with a home domain and a second interface capable of communicating with a local domain roams in the home domain, comprising the steps of:
a step of, when the first interface of the mobile node is attached to the home domain, registering a first proxy binding cache for the first interface with a home agent of the home domain;
a step of, when the second interface of the mobile node is attached to the home domain via the local domain, registering a second proxy binding cache for the second interface with the home agent; and
a step where when the second proxy binding cache for the second interface is registered, the home agent notifies the mobile node so as not to transmit a request to create a client-based binding cache for the second interface, while executing client-based routing relating to the first and the second proxy binding caches.

17. The binding cache creating method according to claim 16, wherein information to create the client-based binding cache for the second interface is transferred between proxy nodes of the home domain.

18. The binding cache creating method according to claim 1, wherein when the mobile node roams from the home domain into a foreign domain, the mobile node notifies the home agent of a request to create the client-based binding cache for the second interface via the foreign domain.

19. (canceled)

20. (canceled)

21. (canceled)

22. (canceled)

23. (canceled)

24. (canceled)

25. (canceled)

26. The home agent according to claim 12, wherein when receiving a proxy binding update message to register the second proxy binding cache for the second interface, the home agent creates the second proxy binding cache, while creating a client-based binding cache for the second interface relating to the first and the created second proxy binding caches, and notifying the mobile node so as not to transmit a request message to register the client-based binding cache.

27. The binding cache creating method according to claim 14, wherein when the mobile node roams from the home domain into a foreign domain, the mobile node notifies the home agent of a request to create the client-based binding cache for the second interface via the foreign domain.

28. The binding cache creating method according to claim 15, wherein when the mobile node roams from the home domain into a foreign domain, the mobile node notifies the home agent of a request to create the client-based binding cache for the second interface via the foreign domain.

29. The binding cache creating method according to claim 16, wherein when the mobile node roams from the home domain into a foreign domain, the mobile node notifies the home agent of a request to create the client-based binding cache for the second interface via the foreign domain.
